(19) United States
(12) Patent Application Publication
(10) Pub. No.: US 2024/0077245 A1
(43) Pub. Date: Mar. 7, 2024

(54) REFRIGERATOR AND METHOD OF CONTROLLING THE SAME

(71) Applicant: LG ELECTRONICS INC., Seoul (KR)

(72) Inventors: Sungwook KIM, Seoul (KR); Sangbok CHOI, Seoul (KR); Namsoo CHO, Seoul (KR)

(21) Appl. No.: 17/766,645

(22) PCT Filed: Oct. 15, 2020
(86) PCT No.: PCT/KR2020/014054

§ 371 Date: Apr. 5, 2022

(30) Foreign Application Priority Data
Oct. 28, 2019 (KR) 10-2019-0134333

(51) Int. Cl. F25D 17/06; F25D 11/02

(52) U.S. Cl. CPC F25D 17/065; F25D 11/02

(57) ABSTRACT

A method for controlling the refrigerator includes turning off a cold air transmission unit and operating a cold air generator with cooling power, which is previously determined, as the temperature of the second storage compartment is equal to or less than a second reference temperature, turning on the cold air transmission unit and operating the cold air generator with the cooling power, which is previously determined, when the temperature of the storage compartment is equal to or greater than a first reference temperature, calculating, by a controller, an operating ratio of the cold air transmission unit based on an ON time and an OFF time of the cold air transmission unit, upon determining that the temperature of the storage compartment is equal to or less than the second reference temperature and adjusting the cooling power of the compressor based on the operating ratio of the cold air transmission unit.

### TECHNICAL FIELD

The present disclosure relates to a refrigerator and a method for controlling the same.

### BACKGROUND ART

A refrigerator is a household appliance for storing food at a low temperature. It is essential to always maintain a storage compartment at a constant low temperature. Currently, in case of a household refrigerator, a storage compartment is maintained at a temperature between upper and lower limits based on a set temperature. That is, the refrigerator is controlled using a method of driving a freezing cycle to cool the storage compartment when the temperature of the storage compartment increases to an upper limit temperature and stopping the freezing cycle when the temperature of the storage compartment reaches a lower limit temperature.

Korean Unexamined Patent Publication No. 1997-0022182 (Publication Date: May 28, 1997) (hereinafter referred to as Prior Art 1) discloses a constant temperature control method of maintaining a storage compartment of a refrigerator at a constant temperature.

According to Prior Art 1, when the temperature of the storage compartment is higher than the setting temperature, the compressor and the fan are driven, the damper of the storage compartment is fully open, and the temperature of the storage compartment is cooled to the setting temperature, the driving of the compressor and/or the fan is stopped and the damper of the storage compartment is closed.

According to Prior art 1, since repeated is a procedure of driving a compressor as the temperature of the storage compartment of the refrigerator is increased to be the set temperature or more, and then stopping the compressor when the temperature of a storage compartment is cooled to the set temperature, the power consumption may be increased when the compressor is driven again.

In addition, since a damper is fully open to cool the storage compartment, cold air may be excessively supplied to the storage compartment in the state that the damper is fully open. Accordingly, the storage compartment is excessively cooled. In other words, the storage compartment may be difficult to maintain a constant temperature.

Further, in the structure that the damper is mounted in a partition wall to partition between a freezing compartment and a refrigerating compartment, and the damper is fully open to cool the refrigerating compartment such that the cold air is supplied from the freezing compartment to the refrigerating compartment, the refrigerating compartment is excessively cooled and the load of the freezing compartment is sharply increased due to the cold air excessively supplied.

Korean Unexamined Patent Document 10-2018-0061753 (published on Jun. 8, 2018) (hereinafter, referred to as “Prior art 2”) discloses a technology to determine a cooling output of a cold air supply unit based on the sum of a cooling output previously determined and a delaying output.

According to Prior art 2, although a cooling output of the cold air supply unit is varied as the cold air supply unit is continuously operated without being stopped, the range of determining the cooling output is limited when the temperature is sharply changed, so the rapid countermeasures are not made against the sharply-changed temperature.

Korean Unexamined Patent Document 10-2019-0005032 (published on Jan. 15, 2018) (hereinafter, referred to as “Prior art 3”) discloses a refrigerator including a cabinet having a storage compartment; a cold air supply unit to operate to supply cold air to the storage compartment; a temperature sensor to sense the temperature of the storage compartment; and a controller to increase or decrease a temperature of the storage compartment, which is sensed by the temperature sensor at regular intervals, and to adjust the output of the cold air supply unit based on the difference between a setting temperature and a current temperature sensed by the temperature sensor.

However, Prior art 3 merely discloses adjusting the output of the cold air supply unit based on the variation in the temperature of the storage compartment, and does not disclose adjusting the output of the cold air supply based on an operating ratio of a cold air transmission unit such as a cooling fan.

### DISCLOSURE OF INVENTION

### Technical Problem

The present embodiment provides a refrigerator which is controlled to maintain a temperature of a storage compartment in a temperature satisfaction range in order to improve freshness of an object to be stored, and a method of controlling the same.

Alternatively or additionally, the present embodiment provides a refrigerator capable of controlling the temperature of a storage compartment to be maintained within a temperature satisfaction range even if a damper is absent in a duct, in the storage compartment to receive cold air through the duct, and a method for controlling the same.

Alternatively or additionally, the present embodiment provides a refrigerator capable of preventing the output of a cold air transmission unit from being determined not to be proper by performing a temperature stabilization operation at an initial stage, and a method for controlling the same.

Alternatively or additionally, the present embodiment provides a refrigerator, capable of reducing power consumption as a cold air generator is continuously operated, and a method for controlling the same.

Alternatively or additionally, the present embodiment provides a refrigerator capable of rapidly recovering a constant temperature state when the temperature of a storage compartment is out of a temperature satisfaction range, and when the temperature of the storage compartment is rapidly out of a constant temperature state.

### Solution to Problem

According to an aspect of the present disclosure, a method for controlling a refrigerator may include calculating, by a controller, an operating ratio of a cold air transmission unit in a procedure of repeatedly turning on and turning off the cold air transmission unit; and determining cooling power of a cold air generator based on the calculated operating ratio.

For example, the method for controlling the refrigerator may include turning off a cold air transmission unit and operating a cold air generator with cooling power, which is previously determined, as a temperature of a storage compartment is equal to or less than a second reference temperature, determining whether the temperature of the storage compartment becomes equal to or greater than a first reference temperature higher than the second reference temperature, turning on the cold air transmission unit and operating the cold air generator with the cooling power, which is previously determined, when the temperature of storage compartment is equal to or greater than the first reference temperature, determining whether the temperature of the storage compartment is equal to or less than the second reference temperature, and calculating, by a controller, an operating ratio of the cold air transmission unit based on an ON time and an OFF time of the cold air transmission unit, upon determining that the temperature of the storage compartment is equal to or less than the second reference temperature, and determining the cooling power of the cold air generator based on the operating ratio of the cold air transmission unit. The method for controlling the refrigerator may further include operating the cold air generator with the determined cooling power.

The cold air generator may be a compressor. The cold air transmission unit may be a cooling fan which operates to provide cold air to the storage compartment or a damper which opens or closes a passage for providing the cold air to the storage compartment.

The storage compartment may receive cold air by the cold air transmission unit from an additional storage compartment communicating with the storage compartment. The temperature of the additional storage compartment may be maintained to be lower than the temperature of the storage compartment.

The controller may turn off the cold air transmission unit when the second reference temperature or less comes.

The operating ratio of the cold air transmission unit may be a ratio of an ON time to a sum of the ON time and the OFF time of the cold air transmission unit.

The controller may determine the cooling power of the cold air generator based on a difference between a previous operating ratio of the cold air transmission unit and a current operating ratio of the cold air transmission unit.

The controller may determine the cooling power of the cold air generator to be increased or decreased, when an absolute value of the difference between the previous operating ratio and the current operating ratio is equal to or greater than a first reference value.

The controller may determine the cooling power of the cold air generator to be maintained when the absolute value of the difference between the previous operating ratio and the current operating ratio is less than the first reference value.

The controller may determine the cooling power of the cold air generator to be increased, when the difference between the previous operating ratio and the current operating ratio is less than zero, and when the absolute value of the difference between the previous operating ratio and the current operating ratio is equal to or greater than the first reference value.

The controller may determine the cooling power of the cold air generator to be decreased, when the difference between the previous operating ratio and the current operating ratio is greater than zero, and when the absolute value of the difference between the previous operating ratio and the current operating ratio is equal to or greater than the first reference value.

The controller may determine the cooling power of the cold air generator to be increased or decreased by a first level, when the absolute value of the difference between the previous operating ratio and the current operating ratio is equal to or greater than the first reference value, and less than a second reference value which is greater than the first reference value, and

The controller may determine the cooling power of the cold air generator to be increased or decreased by a second level which is greater than the first level, when the absolute value of the difference between the previous operating ratio and the current operating ratio is equal to or greater than the second reference value.

The controller may determine the cooling power of the cold air generator based on a difference between a reference operating ratio, which is previously determined, and a current operating ratio of the cold air transmission unit.

The controller may determine the cooling power of the cold air generator to be increased or decreased, when an absolute value of the difference between the reference operating ratio and the current operating ratio is equal to or greater than a first reference value, and

The controller may determine the cooling power of the cold air generator to be maintained, when the absolute value of the difference between the reference operating ratio and the current operating ratio is less than the first reference value.

The controller may determine the cooling power of the cold air generator to be increased, when the difference between the previous operating ratio and the current operating ratio is less than zero, and when the absolute value of the difference between the previous operating ratio and the current operating ratio is equal to or greater than the first reference value.

The controller determines the cooling power of the cold air generator to be decreased, when the difference between the previous operating ratio and the current operating ratio is greater than zero, and when the absolute value of the difference between the previous operating ratio and the current operating ratio is equal to or greater than the first reference value.

The controller may determine the cooling power of the cold air generator to be increased or decreased by a first level, when the absolute value of the difference between the reference operating ratio and the current operating ratio is equal to or greater than the first reference value, and less than a second reference value which is greater than the first reference value.

The controller may determine the cooling power of the cold air generator to be increased or decreased by a second level which is greater than the first level, when the absolute value of the difference between the reference operating ratio and the current operating ratio is equal to or greater than the second reference value.

The controller may determine the cooling power of the cold air generator based on a first factor which is a difference between a previous operating ratio of the cold air transmission unit and a current operating ratio of the cold air transmission unit, and a second factor which is a difference between a reference operating ratio, which is previously determined, and the current operating ratio of the cold air transmission unit.

The controller may determine the cooling power of the cold air generator based on the first factor, determine the cooling power of the cold air generator based on the second factor, and combine the results from the first factor and the second factor, thereby determining the cooling power of the cold air generator to be increased, maintained, or decreased.

According to another aspect of the present disclosure, a method for controlling a refrigerator includes a first storage compartment, a second storage compartment to receive cold air to cool the first storage compartment, a temperature sensor to sense a temperature of the second storage compartment, a cooling fan to supply the cold air to the second storage compartment, and a compressor to operate to cool the first storage compartment.

The method for controlling the refrigerator may include calculating an operating ratio of a cooling fan in a procedure of repeatedly turning on and off the cooling fan, and determining cooling power of a compressor based on the calculated operating ratio.

For example, the method for controlling the refrigerator may include turning off the cooling fan and operating the compressor with the cooling power, which is previously determined, when the temperature of the second storage compartment is equal to or less than the second reference temperature, determining whether the temperature of the second storage compartment becomes equal to or greater than a first reference temperature higher than the second reference temperature, turning on the cooling fan and operating the compressor with the cooling power, which is previously determined, when the temperature of the second storage compartment is equal to or greater than the first reference temperature, determining whether the temperature of the second storage compartment is equal to or less than the second reference temperature, calculating, by a controller, an operating ratio of the cooling fan based on an ON time and an OFF time of the cooling fan, upon determining that the temperature of the second storage compartment is equal to or less than the second reference temperature, and determining the cooling power of the compressor based on the operating ratio of the cooling fan.

The method for controlling the refrigerator may further include operating the compressor with the determined cooling power.

The first storage compartment may be a freezing compartment, and the second storage compartment may be a refrigerating compartment.

The controller may determine the cooling power of the compressor based on a difference between a previous operating ratio of the cooling fan and a current operating ratio of the cooling fan.

The controller may determine the cooling power of the compressor based on a difference between a reference operating ratio, which is previously determined, and a current operating ratio of the cooling fan.

The controller may determine the cooling power of the compressor based on a first factor which is a difference between a previous operating ratio of the cold air transmission unit and a current operating ratio of the cooling fan, and a second factor which is a difference between a reference operating ratio, which is previously determined, and the current operating ratio of the cooling

According to another aspect, the present disclosure relates to a method for controlling a refrigerator including a cold air generator to generate cold air to cool a storage compartment, and a cold air transmission unit to transmit cold air to the storage compartment.

The method for controlling the refrigerator may include decreasing a temperature of a storage compartment to a lower limit temperature as the refrigerator is powered on, operating a cold supply unit and a cold air transmission unit such that the temperature of the storage compartment enters in the range of the first reference temperature and the second reference temperature, and operating the cold air supply unit and the cold air transmission unit such that the temperature of the storage compartment is maintained in the range of the first reference temperature and the second reference temperature.

The operating of the cold air supply unit and the cold air transmission unit such that the temperature of the storage compartment is maintained in the range of the first reference temperature and the second reference temperature may include calculating the operating ratio of the cold air transmission unit in the procedure of repeatedly turning on and off the cold air transmission unit, and determining cooling power of a cold air generator based on the calculated operating ratio.

For example, the method for controlling the refrigerator may include operating the cold air generator with setting power and operating the cold air transmission unit with the setting output as the refrigerator is powered on, determining whether the temperature of the storage compartment reaches the lower limit temperature, reducing the output of the cold air transmission unit to be lower than the setting output, when the temperature of the storage compartment reaches the lower limit temperature, and operating the cold air generator with the reference power, and operating the cold air transmission unit with reference power, when the temperature of the storage compartment is equal to or greater than the first reference temperature higher than the lower limit temperature.

The method for controlling the refrigerator may include turning off the cold air transmission unit and operating the cold air generator with the reference cooling power when the temperature of the storage compartment is equal to or less than a second reference temperature between the first reference temperature and the lower limit temperature, turning on the cold air transmission unit and operating the cold air generator with the reference cooling power, when the temperature of the storage compartment is equal to or greater than the first reference temperature, turning off the cold air transmission unit, and calculating the operating ratio of the cold air transmission unit based on the ON time and the OFF time of the cold air transmission unit, when the temperature of the storage compartment is equal to or less than the second reference temperature, and determining, by the controller, cooling power of the cold air generator, based on the calculated operating ratio, and operating the cold air generator with the determined cooling power.

The reference cooling power of the cold air transmission unit may be smaller than the setting cooling power.

When the temperature of the storage compartment reaches the lower limit temperature, the cold air transmission unit may be turned off or may be operated with output lower than the setting output.

The controller may repeatedly turn off and on the cold air transmission unit such that the temperature of the storage compartment is maintained to be in the range of the first reference temperature and the second reference temperature.

The operating ratio of the cold air transmission unit is repeatedly calculated in one operating period obtained through the sum of the ON time and the OFF time of the cold air transmission unit, and the controller may determine the cooling power of the cold air generator based on the calculated operating ratio.

The controller may determine the cooling power of the cold air generator based on a difference between a previous operating ratio of the cold air transmission unit and a current operating ratio of the cold air transmission unit.

The controller may determine the cooling power of the cold air generator based on a difference between a reference operating ratio, which is previously determined, and a current operating ratio of the cold air transmission unit.

The controller may determine the cooling power of the cold air generator based on a first factor which is a difference between a previous operating ratio of the cold air transmission unit and a current operating ratio of the cold air transmission unit, and a second factor which is a difference between a reference operating ratio, which is previously determined, and the current operating ratio of the cold air transmission unit.

According to another aspect, a refrigerator may include a first storage compartment, a second storage compartment to receive cold air to cool the first storage compartment, a temperature sensor to sense a temperature of the second storage compartment, a cooling fan to supply the cold air to the second storage compartment, and a compressor to operate to cool the first storage compartment, and a controller to control the compressor.

The controller repeatedly turns on and off the cooling fan based on the temperature of the second storage compartment such that the temperature of the second storage compartment is maintained in a range of a first reference temperature and a second reference temperature lower than the first reference temperature.

The controller may perform a control operation to determine the cooling power of the compressor based on an operating ratio of the cooling fan which is a ratio of an ON time to a sum of the ON time and the OFF time of the cooling fan, and operate the compressor with the determined cooling power.

According to another embodiment, a method for controlling a refrigerator includes a cold air generator to generate cold air for cooling a storage compartment, and a cold air transmission unit to transmit the cold air to the storage compartment. The method may include operating the cold air generator with set cooling power and operating the cold air transmission with the setting output, after the initial operating condition is satisfied, determining whether the temperature of the storage compartment reaches the lower limit temperature A2, reducing the output of the cold air transmission unit to be lower than the setting output and continuously operating the cold air generator with the reference cooling power, after the temperature of the storage compartment reaches the lower limit temperature A2, operating the cold air transmission unit with the reference output, when the temperature of the storage compartment is equal to or greater than the first reference temperature H1 higher than the lower limit temperature, and reducing the output of the cold air transmission unit to be lower than the reference output and continuously operating the cold air generator with the reference cooling power, when the temperature of the storage compartment is equal to or greater than the second reference temperature H2 between the first reference temperature and the lower limit temperature.

The method for controlling the refrigerator further include more increasing the output of the cold air transmission unit as compared to that in the previous stage and continuously operating the cold air generator with the reference cooling power, when the temperature of the storage compartment is equal to or greater than the first reference temperature, more reducing the output of the cold air transmission unit as compared to that in the previous stage and continuously operating the cold air generator with the reference cooling power when the temperature of the storage compartment is less than or greater than the second reference temperature, and calculating the operating ratio of the cold air transmission unit, based ON time at which the output of the cold air transmission unit is increased and time at which the output of the cold air transmission unit is reduced.

The method for controlling the refrigerator may further include calculating the operating ratio of the cold air transmission unit at least two times, determining, by the controller, cooling power of the cold air generator based on the difference between the previous operating ratio of the cold air transmission unit and the current operating ratio of the cold air transmission unit and operating the cold air generator with the determined cooling power.

The initial operating condition may include at least one of the case that the refrigerator is powered on, the case that the starting condition of the operation corresponding to the door load of the refrigerator is satisfied, or the case that the condition of terminating the defrost operation of the refrigerator is satisfied.

The controller may determine the cooling power of the cold air generator based on a first factor which is a difference between a previous operating ratio of the cold air transmission unit and a current operating ratio of the cold air transmission unit, and a second factor which is a difference between a reference operating ratio, which is previously determined, and the current operating ratio of the cold air transmission unit.

The operating ratio of the cold air transmission unit may be determined based on (the operating time in the state that the output of the cold air transmission unit is increased)/(the operating time in the state that the output of the cold air transmission unit is increased+the operating time in the state that the output of the cold air transmission unit is decreased.

The cooling power of the cold air generator in the current stage may be determined through MVT=MVₜ₋₁−(Kₚ(eₜ−eₜ₋₁)+Kieₜ).

In this case, MV_{T} is the cooling power of the cold air generator in the current stage, MVₜ₋₁ is the cooling power of the cold air generator in the previous stage, Kₚ is a control constant of ‘P’, Ki is a control constant of T, and et represents (target operating ratio of cold air transmission unit-operating ratio of cold air transmission unit in current stage), or eₜ₋₁ represents (target operating ratio of cold air transmission unit-operating ratio of cold air transmission unit in previous stage).

The cold air generator may be a compressor. The cold air transmission unit may be a cooling fan which operates to provide cold air to the storage compartment or a damper which opens or closes a passage for providing the cold air to the storage compartment.

The refrigerator may include an evaporator, a first storage compartment, and a second storage compartment maintained at a temperature lower than that of the first storage compartment.

The evaporator and the cooling fan may be disposed closer to the second storage compartment rather than the first storage compartment. The refrigerator may additionally include a knob to adjust that cold air generated from the second storage compartment is transmitted to the first storage compartment.

### Advantageous Effects of Invention

According to the embodiment that is suggested, the temperature of the storage compartment is maintained within the temperature satisfaction range, the freshness of a stored object may be improved.

In addition, since the cooling power of the cold air generator is varied based on the operating ratio of the cold air transmission unit, the cooling power of the cold air generator is adjusted in the state that the cold air generator is not turned off, thereby preventing the power consumption from being increased due to the repeated turning on/off operations of the cold air generator.

Even if the cold air generator is continuously operated, the cooling power of the cold air generator is maintained to cooling power lower than the intermediate cooling power between the maximum cooling power and the minimum cooling. Accordingly, the power consumption of the cold air generator may be minimized.

Since the cooling power of the cold air generator is adjusted in a plurality of levels, the temperature of the storage compartment may be returned to be in the temperature satisfaction range, even if the temperature of the storage compartment is rapidly increased or decreased.

### BRIEF DESCRIPTION OF DRAWINGS

FIG. 1 is a diagram schematically showing the configuration of a refrigerator according to a first embodiment of the present disclosure.

FIG. 2 is a block diagram of a refrigerator according to a first embodiment of the present disclosure.

FIGS. 3 to 5 are flowcharts illustrating a method of controlling a refrigerator according to a first embodiment of the present disclosure.

FIG. 6 is a view showing a temperature change of a refrigerating compartment and an operation state of a cooling fan over time.

FIG. 7 is a graph illustrating the variation in an operating ratio of a cold air transmission unit and an output control of the cold air generator.

FIG. 8 is a view schematically illustrating the configuration of the refrigerator according to a second embodiment of the present disclosure.

FIG. 9 is a view schematically illustrating the configuration of the refrigerator according to a third embodiment of the present disclosure.

FIG. 10 is a view schematically illustrating the configuration of the refrigerator according to a fourth embodiment of the present disclosure.

### MODE FOR THE INVENTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, coupled” or “joined” to the latter with a third component interposed therebetween.

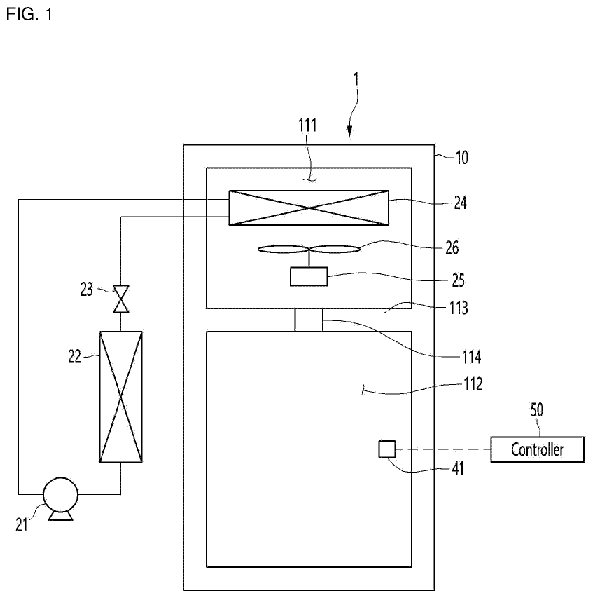

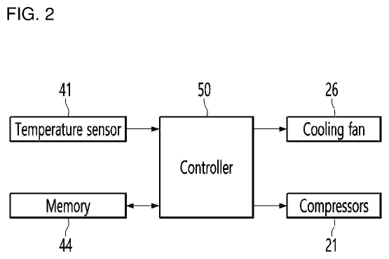

FIG. 1 is a diagram schematically showing the configuration of a refrigerator according to a first embodiment of the present disclosure, and FIG. 2 is a block diagram of a refrigerator according to a first embodiment of the present disclosure.

Referring to FIGS. 1 and 2, the refrigerator 1 according to the first embodiment of the present disclosure may include a cabinet 10 in which a storage compartment is formed and a storage compartment door coupled to the cabinet 10 to open and close the storage compartment.

The storage compartment may include a freezing compartment 111 and a refrigerating compartment 112. Objects to be stored such as food may be stored in the freezing compartment 111 and the refrigerating compartment 112.

Although FIG. 1 shows, for example, a refrigerator in which the freezing compartment 111 and the refrigerating compartment 112 are arranged in a vertical direction, in the present disclosure, arrangement of the freezing compartment and the refrigerating compartment is not limited and the type of the refrigerator is not limited.

For example, the freezing compartment 111 may be located above the refrigerating compartment 112.

The freezing compartment 111 and the refrigerating compartment 112 may be partitioned in the vertical direction inside the cabinet 10 by a partitioning wall 113. In the partitioning wall 113, a cold air duct 114 for providing a cold air passage for supplying cold air of the freezing compartment 111 to the refrigerating compartment 112 may be provided.

The refrigerator 1 may further include a freezing cycle for cooling the freezing compartment 111 and/or the refrigerating compartment 112.

The freezing cycle may include a compressor 21 for compressing refrigerant, a condenser 22 for condensing the refrigerant which has passed through the compressor 21, an expansion member 23 for expanding the refrigerant which has passed through the condenser 22, and an evaporator 24 for evaporating the refrigerant which has passed through the expansion member 23.

The evaporator 24 may include, for example, a freezing compartment evaporator. That is, the cold air heat-exchanged with the evaporator 24 may be supplied to the freezing compartment 111, and the cold air of the freezing compartment 111 may be supplied to the refrigerating compartment 112 through the cold air duct 114.

In another example, in the cabinet 10, the cold air duct 114 may be disposed at a position other than the partitioning wall 113 such that the cold air of the freezing compartment 111 is guided to the refrigerating compartment 112.

The refrigerator 1 may include a cooling fan 26 for allowing air to flow toward the evaporator 24 for circulation of cold air of the freezing compartment 111 and a fan driving unit 25 for driving the cooling fan 26.

The damper may not be provided in the cold air duct 114. According to the present embodiment, the amount of cold air supplied to the refrigerating compartment 112 may be determined according to ON/OFF of the cooling fan 26 and the rotation speed (RPM) of the cooling fan 26. The temperature of the refrigerating compartment 112 may be changed by the amount of cold air supplied to the refrigerating compartment 112.

In the present embodiment, in order to supply cold air to the freezing compartment 111, the compressor 21 and the cooling fan 26 (or the fan driving unit 25) need to operate.

In the present disclosure, the compressor 21 and the cooling fan 26 (or the fan driving unit 25) may be collectively referred to as a “cooling unit” which operates to cool the storage compartment.

The cooling unit may include one or more of a cold air generator operating to generate cold air and a cold air transmission unit (cold air transmitter) operating to transit cold air.

The compressor 21 may be called a cold air generator and the cooling fan 26 may be called a cold air transmission unit.

In the present disclosure, the cooling power (or output) of the cold air generator may mean, for example, the cooling power (or output) of the compressor 21 and the output of the cold air transmission unit may mean, for example, the rotation speed of the cooling fan 26.

The operating ratio of the cold air transmission unit may mean a ratio of an ON time to a sum of the ON time and the OFF time of the cooling fan 26 in one ON/OFF period of the cooling fan 26. Accordingly, the operating ratio of the cold air transmission unit being high mean that the ON time of the cooling fan 26 is long, and the operating ratio of the cold air transmission unit being low means that the ON time of the cooling fan 26 is short.

The refrigerator 1 may further include a temperature sensor 41 to sense the temperature of the refrigerating compartment 112 and a controller 50 to control the cold air generator based on the temperature sensed by the temperature sensor 41.

The controller 50 may control one or more of the compressors 21 and the cooling fan 26 such that the temperature of the refrigerating compartment 112 is maintained in a temperature satisfaction range.

For example, the controller 50 may turn on/off the cooling fan 26 or change the rotation speed of the cooling fan 26. The controller 50 may increase, maintain or decrease the cooling power of the compressor 21.

The controller 50 may change the cooling power (or output) of the compressor 21 based on the operating ratio of the cooling fan 26.

The refrigerator 1 may further include a memory 44. In the memory 44, a set temperature (or a target temperature) may be stored. The set temperature may be input through an input (not shown) or may be a temperature basically set in a product. In the memory 44, information on the operating ratio of the cooling fan 26 may be stored.

In the present disclosure, a temperature higher than the set temperature of the refrigerating compartment 112 may be referred to as a first reference temperature and a temperature lower than the set temperature of the refrigerating compartment 112 may be referred to as a second reference temperature.

In addition, a temperature higher than the first reference temperature may be referred to as an upper limit temperature and the second reference temperature may be referred to as a lower limit temperature.

A range between the first reference temperature and the second reference temperature may be referred to as a temperature satisfaction range. The set temperature may be, for example, an average temperature between the first reference temperature and the second reference temperature.

Hereinafter, a method of controlling a refrigerator in order to maintain the temperature of the refrigerating compartment 112 in the temperature satisfaction range will be described.

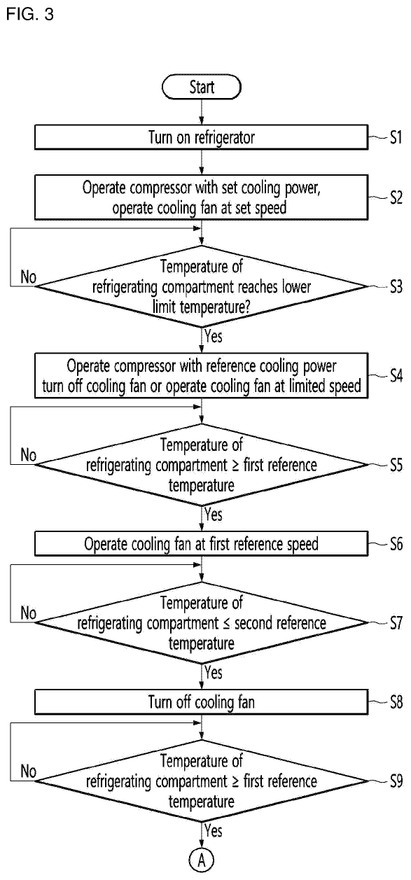

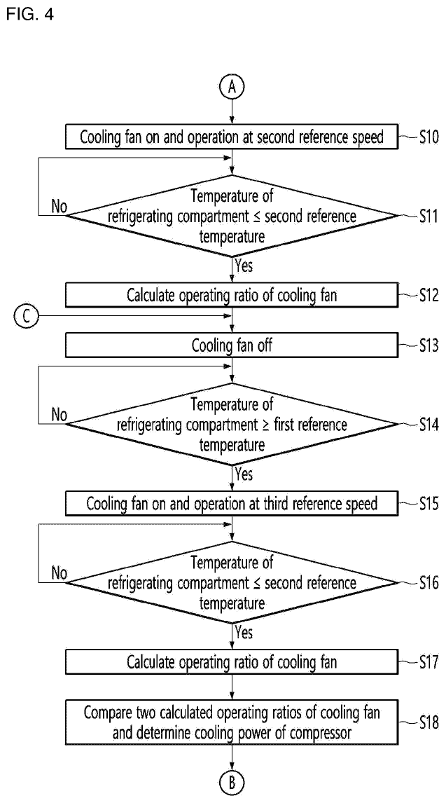

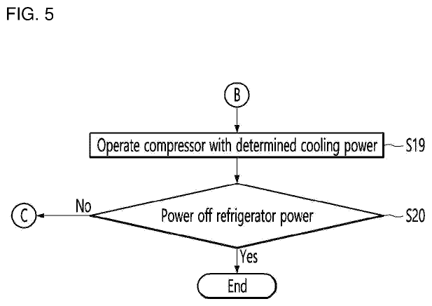

FIGS. 3 to 5 are flowcharts illustrating a method of controlling a refrigerator according to a first embodiment of the present disclosure.

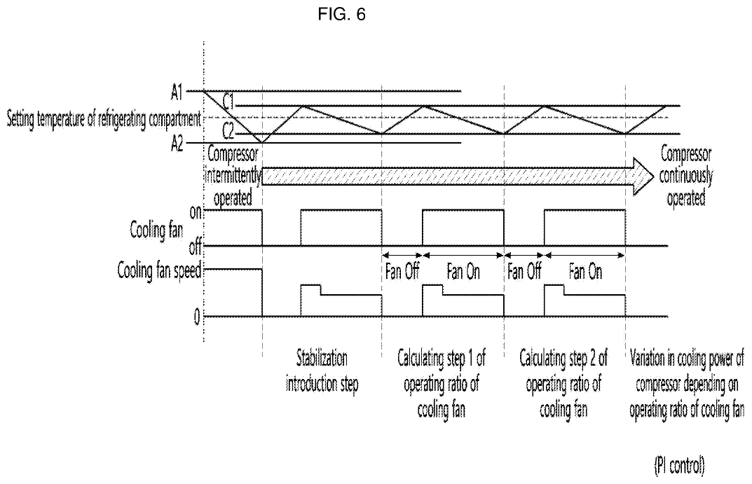

FIG. 6 is a view illustrating the variation in the temperature of the refrigerating compartment and the operating state of the cooling fan over time.

Referring to FIGS. 2 to 6, the controller 50 may perform preliminary operation for constant temperature control when the refrigerator 1 is turned on (S1) (or opening and closing of a door are detected). In the present embodiment, the preliminary operation may be operation of rapidly reducing the temperature of the refrigerating compartment 112.

For example, the controller 50 may perform control such that the compressor 21 operates with cooling power and the cooling fan 26 operates at a set speed (S2).

The set speed may be, but the present disclosure is not limited to, the maximum speed.

Generally, when the refrigerator 1 is turned on or the compressor 21 is turned on in a state in which the compressor is turned off, the cold air generator is turned off for defrost or the door is open and closed, the temperature of the refrigerating compartment 112 may be higher than the ON reference temperature A1.

Accordingly, the set cooling power of the compressor 21 may be, for example, maximum cooling power or power close to the maximum cooling power, such that the temperature of the refrigerating compartment 112 rapidly drops. In addition, the set speed of the cooling fan 26 may be, for example, a maximum speed or a speed close to the maximum speed.

When the compressor 21 and the cooling fan 26 operate, the temperature of the refrigerating compartment 112 decreases.

The controller 50 may determine whether the temperature of the refrigerating compartment 112 becomes equal to or less than the lower limit temperature A2 (or a change reference temperature) for example (S3).

Upon determining that the temperature of the refrigerating compartment 112 reaches the lower limit temperature A2 in step S3, the controller 50 may perform control to perform temperature stabilization operation.

That is, the controller 50 may perform control to perform temperature stabilization operation after the preliminary operation is completed (S4 to S6).

The temperature stabilization operation means operation of allowing the temperature of the refrigerating compartment 112 to enter the temperature satisfaction range.

For example, the controller 50 may operate the compressor 21 with reference cooling power (S4).

The reference cooling power may be cooling power between maximum and minimum cooling power of the compressor 21. For example, the reference cooling power may be less than intermediate cooling power between the maximum and minimum cooling power of the compressor 21.

In addition, the controller 50 may perform control such that the cooling fan 26 is turned off or the cooling fan 26 operates at a limited speed (S4).

The limited speed may be, for example, a minimum speed (greater than zero) of the cooling fan 26 or a speed close to the minimum speed.

When the cooling fan 26 is operated at the limited speed, the temperature of the refrigerating compartment 112 may be increased. In other words, the temperature of the refrigerating compartment 112 may be increased, as an amount of cold air supplied to the refrigerating compartment 112 through the operation of the cooling fan 26 is more reduced as compared to when the cooling fan 26 operates at the set speed.

The controller 50 may determine whether the temperature of the refrigerating compartment 112 is equal to or greater than the first reference temperature during operation of the compressor 21 (S5).

Upon determining that the temperature of the refrigerating compartment 112 is equal to or greater than the first reference temperature according to the determination result in step S5, the controller 50 may operate the cooling fan at a first reference speed in a state in which the compressor 21 operates (S6).

In the present embodiment, the first reference speed may be greater than the limited speed.

For example, when the cooling fan 26 operates at the first reference speed, the first reference speed may be set to decrease the temperature of the refrigerating compartment 112.

In other words, when the cooling fan 26 operates at a first reference speed, an amount of cold air supplied to the refrigerating compartment 112 is increased as compared to when the cooling fan 26 operates at the limited speed, such that the temperature of the refrigerating compartment 112 may be decreased.

The first reference speed may be a fixed speed. In addition, the first reference speed may be varied at least one time.

If the first reference speed is varied at least one time, the first reference speed may be varied to a second speed, which is lower than the first speed, from the first speed.

When the cooling fan 26 operates at the first speed, an amount of cold air to be supplied to the refrigerating compartment 112 is increased, thereby increasing the speed of decreasing the temperature of the refrigerating compartment 112.

After the temperature of the refrigerating compartment 112 is decreased to some extent, the rotation speed of the cooling fan 26 is decreased to the second speed, thereby reducing the speed of decreasing the temperature of the refrigerating compartment 112. In this case, the variation per hour in the temperature of the air compressor 10 may be reduced.

In this case, a time point, at which the rotation speed of the cooling fan 26 is varied from the first speed to the second speed, may be determined over time or may be determined based on the temperature of the refrigerating compartment 112.

For example, when the cooling fan 26 is operated at the first speed, and the setting time is elapsed, the cooling fan 26 may be operated at the second speed.

Alternatively, while the cooling fan 26 is operating at the first speed, when the temperature of the refrigerating compartment 112 reaches the third reference temperature between the first reference temperature and the second reference temperature, the cooling fan 26 may be operated at the second speed.

The controller 50 may determine whether the temperature of the refrigerating compartment 112 is equal to or less than the second reference temperature (S7).

Upon determining that the temperature of the refrigerating compartment 112 is equal to or less than the second reference temperature in step S7, the controller 50 may perform control to perform constant temperature operation.

The controller 50 may perform control to repeat operation of turning off and then turning on the cooling fan 26 in the constant temperature operation step.

In the present disclosure, a period from when the cooling fan 26 is turned on after being turned off to when the cooling fan is turned off again may be referred to as one operating period.

The controller 50 may calculate the operating ratio of the cooling fan 26 for each operating cycle during two operating cycles and may determine the cooling power of the compressor 21 based on the calculated two operating ratios, in the constant temperature operation step.

The controller 50 may operate the compressor 21 with the determined cooling power in a next operating cycle.

Upon determining that the temperature of the refrigerating compartment 112 is equal to or less than the second reference temperature in step S7, the controller 50 turns off the cooling fan 26 in a state in which operation of the compressor 21 is maintained (S8).

When the cooling fan 26 is turned off, the temperature of the refrigerating compartment 112 may increase.

While the temperature of the refrigerating compartment 112 increases, the controller 50 may determine whether the temperature of the refrigerating compartment 112 is equal to or greater than the first reference temperature (S9).

Upon determining that the temperature of the refrigerating compartment 112 is equal to or greater than the first reference temperature C1 in step S9, the controller 50 may turn on the cooling fan 26 and control the cooling fan 26 such that the cooling fan 26 operates at a second reference speed (S10).

In step S10, when the cooling fan 26 operates at the second reference speed, the temperature of the refrigerating compartment 112 may decrease. The second reference speed may be equal to or different from the first reference speed.

The second reference speed may be identical to or different from the first reference speed.

The second reference speed may be a fixed speed or may be varied one or more times as described above in association with the first reference speed. Since the case where the second reference speed is varied may be the same as the case where the first reference speed is varied, the details thereof will be omitted.

The controller 50 may determine whether the temperature of the refrigerating compartment 112 is equal to or less than the second reference temperature while the cooling fan 26 is operated at the second reference speed (S11).

Upon determining that the temperature of the refrigerating compartment 112 becomes equal to or less than the second reference temperature in step S11, the controller 50 may calculate the operating ratio of the cooling fan 26 based on the ON time and OFF time of the cooling fan 26 in steps S8 to S10 (S12). The calculated operating ratio of the cooling fan 26 may be stored in the memory 44.

In addition, upon determining that the temperature of the refrigerating compartment 112 becomes equal to or less than the second reference temperature in step S11, the controller 50 may turn off the cooling fan 26 in a state in which operation of the compressor 21 is maintained (S13).

When the cooling fan 26 is turned off, the temperature of the refrigerating compartment 112 may increase.

In a state in which the cooling fan 26 is turned off, the controller 50 may determine whether the temperature of the refrigerating compartment 112 becomes equal to or greater than the first reference temperature C1 (S14).

When the temperature of the refrigerating compartment 112 becomes equal to or greater than the first reference temperature, according to the determination result of step S14, the controller 50 may control the cooling fan 26 such that the cooling fan 26 is turned on and operated at a third reference speed (S15).

In step S15, when the cooling fan 26 is operated at the third reference speed, the temperature of the refrigerating compartment 112 may be reduced.

The third reference speed may be equal to at least one of the first reference speed or the second reference speed, or may be different from the first reference speed and the second reference speed.

The third reference speed may be a fixed speed or may be varied one or more times as described above in association with the first reference speed. Since the case where the third reference speed is varied may be the same as the case where the first reference speed is varied, the details thereof will be omitted.

The controller 50 may determine whether the temperature of the refrigerating compartment 112 is equal to or less than the second reference temperature while the cooling fan 26 is operated at the third reference speed (S16).

Upon determining that the temperature of the refrigerating compartment 112 becomes equal to or less than the second reference temperature in step S16, the controller 50 may calculate the operating ratio of the cooling fan 26 based on the ON time and OFF time of the cooling fan 26 in steps S13 to S15 (S17). The calculated operating ratio of the cooling fan 26 may be stored in the memory 44.

In other words, in the memory 44, the operating ratio of the cooling fan 26 may be calculated and stored for each operating period.

For convenience of description, the operating ratio calculated in step S12 may be referred to as a previous operating ratio and the operating ratio calculated in step S17 may be referred to as a current operating ratio.

When a current operating ratio is calculated, the controller 50 may determine the cooling power of the compressor 21 by comparing the previous operating ratio with the current operating ratio (S18).

The controller 50 may operate the compressor 21 with the determined cooling power (S19).

In other words, the controller 50 may perform a control operation such that the compressor 21 is operated with the determined cooling power in a next operating cycle.

As illustrated in FIG. 6, when one operating cycle is terminated at a time point at which the cooling fan 26 is turned off, the operating ratio of the cooling fan 26 may be determined at the time point at which the cooling fan 26 is turned off. Accordingly, the cooling power of the compressor 21 may be determined at the time point at which the cooling fan 26 is turned off. In this case, the cooling power of the compressor 21 may be changed at or after the time point at which the cooling fan 26 is turned off.

When one operating cycle is terminated at a time point at which the cooling fan 26 is turned on, the operating ratio of the cooling fan 26 may be determined at the time point at which the cooling fan 26 is turned on. Accordingly, the cooling power of the compressor 21 may be determined at the time point at which the cooling fan 26 is turned on. In this case, the cooling power of the compressor 21 may be changed at or after the time point at which the cooling fan 26 is turned on.

As long as the refrigerator is not powered off (S20), the controller 50 may continuously perform the constant temperature operation to vary the cooling power of the compressor 21 in the state that the compressor 21 is turned on.

For example, when the compressor 21 is rotated at the determined cooling power, the controller 50 may repeatedly perform step S13 to S19.

When steps S13 to S19 are repeatedly performed, the operating ratio of the cooling fan 26 is calculated for each operating period, the last calculated operating ratio becomes a current operating ratio and the previously calculated operating ration becomes a previous operating ratio.

According to the present embodiment, the controller 50 may determine the cooling power of the compressor 21 based on a difference value between the previous operating ratio and the current operating ratio of the cooling fan 26.

For example, when the absolute value of the difference between the previous operating ratio and the current operating ratio of the cooling fan 26 is less than the first reference value, the controller 50 may maintain the cooling power of the compressor 21 to be current cooling power. In other words, the controller 50 does not vary the cooling power of the compressor 21.

Alternatively when the absolute value of the difference between the previous operating ratio and the current operating ratio of the cooling fan 26 is equal to or greater than the first reference value, the controller 50 may increase or decrease the cooling power of the compressor 21.

For example, when the difference between the previous operating ratio and the current operating ratio is less than zero and the absolute value of the difference between the previous operating ratio and the current operating ratio is equal to or greater than the first reference value, the cooling power of the compressor 21 may be increased by the first level.

The difference between the previous operating ratio and current operating ratio being less than zero may mean that the current operating ratio is greater than the previous operating ratio.

The current operating ratio being greater than the previous operating ratio means that the operating time of the cooling fan 26 increases. Increasing the operating time of the cooling fan 26 means that a time required for the temperature of the refrigerating compartment 112 to increase from the first reference temperature to reach the second reference temperature increases.

When the cooling power of the compressor 21 shows lower cooling power, the cold air supplied to the refrigerating compartment 112 may shows a higher temperature.

When the temperature of cold air actually supplied to the refrigerating compartment 112 is higher than the temperature of cold air matched with a current load of the refrigerating compartment 112, time, which is taken until the temperature of the refrigerating compartment 112 reaches the second reference temperature from the first reference temperature, may be increased.

Accordingly, according to the present embodiment, when the difference between the previous operating ratio and the current operating ratio is less than zero and the absolute value of the difference between the previous operating ratio and the current operating ratio is equal to or greater than the first reference value, the cooling power of the compressor 21 may be increased by the first level.

Alternatively, when the difference between the previous operating ratio and the current operating ratio is greater than zero and the absolute value of the difference between the previous operating ratio and the current operating ratio is equal to or greater than the first reference value, the cooling power of the compressor 21 may be decreased by the first level.

The difference between the previous operating ratio and the current operating ratio being greater than zero means that the current operating ratio is less than the previous operating ratio.

The current operating ratio being less than the previous operating ratio means that the operating time of the cooling fan 26 decreases. Decreasing the operating time the cooling fan 26 means that a time required for the temperature of the refrigerating compartment 112 to increase from the first reference temperature to reach the second reference temperature decreases.

When the cooling power of the compressor 21 shows higher cooling power, the cold air supplied to the refrigerating compartment 112 may shows a lower temperature.

When the temperature of cold air actually supplied to the refrigerating compartment 112 is lower than the temperature of cold air matched with a current load of the refrigerating compartment 112, time, which is taken until the temperature of the refrigerating compartment 112 reaches the second reference temperature from the first reference temperature, may be decreased.

Accordingly, according to the present embodiment, when the difference between the previous operating ratio and the current operating ratio is greater than zero and the absolute value of the difference between the previous operating ratio and the current operating ratio is equal to or greater than the first reference value, the cooling power of the compressor 21 may be decreased by the first level.

In the present embodiment, a plurality of reference values for comparison with the absolute value of the difference between the previous operating ratio and the current operating ratio may be set.

For example, when the difference between the previous operating ratio and the current operating ratio is less than zero and the absolute value of the difference between the previous operating ratio and the current operating ratio is equal to or greater than the second reference value which is greater than the first reference value, the cooling power of the compressor 21 may be increased by the second level.

Alternatively, when the absolute value of the difference between the previous operating ratio and the current operating ratio is equal to or greater than the third reference value which is greater than the second reference value, the cooling power of the compressor 21 may be increased by the third level. Alternatively, when the absolute value of the difference between the previous operating ratio and the current operating ratio is equal to or greater than the third reference value which is greater than the second reference value, the cooling power of the compressor 21 may be determined as the maximum speed.

Further, when the difference between the previous operating ratio and the current operating ratio is greater than zero and the absolute value of the difference between the previous operating ratio and the current operating ratio is equal to or greater than the second reference value which is greater than the first reference value, the cooling power of the compressor 21 may be decreased by the second level.

Alternatively, when the absolute value of the difference between the previous operating ratio and the current operating ratio is equal to or greater than the third reference value which is greater than the second reference value, the cooling power of the compressor 21 may be determined as the maximum speed. Alternatively, when the absolute value of the difference between the previous operating ratio and the current operating ratio is equal to or greater than the third reference value which is greater than the second reference value, the cooling power of the compressor 21 may be determined as the minimum speed.

At this time, the differences between the plurality of reference values may be equally or differently determined.

For example, the first reference value may be set to B1, the second reference value may be set to 2*B1, and the third reference value may be set to 3*B1. Alternatively, the first reference value may be set to B2, the second reference value may be set to C*B2, and the third reference value may be set to C1*B2. At this time, C1 may have a value greater than C.

In addition, the differences between the plurality of levels may be equally or differently set.

For example, the first level may have a cooling power change value of D, the second level may have a cooling power change value of 2*D, and the third level may be set as a cooling power change value of 3*D.

Alternatively, the first level may have a cooling change value of D, the second level may be set to a cooling power change value of D1 (a value greater than D) instead of the value of 2*D, and the third level may be set to have a cooling power change value of D2 (a value greater than D1) instead of 3*D.

According to the present embodiment, since the cooling power of the compressor 21 may be varied based on the result of the comparison between the previous operating ratio and the current operating ratio of the cooling fan 26, the cooling power of the compressor 21 may be adjusted without turning off the compressor 21, thereby preventing the power consumption from being increased due to the repeated ON/OFF operations of the compressor 21.

The cooling power of the compressor 21 may converge to a specific cooling power during a constant temperature operation or may operate with cooling power similar to the specific cooling power. The cooling power of the compressor 21, which is cooling power for actually maintaining the temperature of the refrigerating compartment 112 within the temperature satisfaction range, may be smaller than intermediate cooling power of the compressor 21.

Accordingly, even if the compressor 21 is continuously operated, since the cooling power of the compressor 21 is maintained to be smaller than the intermediate cooling power, the increase in the power consumption of the compressor 21 may be minimized.

Since the temperature of the refrigerating compartment 112 is maintained in the temperature satisfaction range, the temperature change range of the object to be stored, which is stored in the refrigerating compartment 112, may be minimized and freshness of the object to be stored may be maintained.

In addition, since the cooling power of the compressor 21 may be adjusted to a plurality of levels, when the temperature of the refrigerating compartment 112 rapidly increases or decreases (for example, when the door is opened, when the door is opened and cold air having a temperature lower than the temperature of the refrigerating compartment 112 is supplied to the refrigerating compartment 112 or when air outside the refrigerator is supplied to the refrigerating compartment 112), the temperature of the refrigerating compartment 112 may be rapidly returned to the temperature satisfaction range.

The present embodiment will be summarized as follows. In the constant temperature operation step, the compressor 21 is operated with the cooling power previously determined. When one operating cycle is completed, the current operating ratio of the cooling fan 26 is obtained to determine a cooling power of the compressor 21 to be operated in a next operating cycle, and the compressor 21 is rotated with the determined cooling power.

In the present disclosure, any one of the freezing compartment 111 and the refrigerating compartment 112 may be referred to as a first storage compartment and the other thereof may be referred to as a second storage compartment.

When a temperature sensor is present in the freezing compartment 111, ON and OFF of the cooling fan 26 may be determined according to the temperature change of the freezing compartment 111. In this case, the cooling power of the compressor 21 may be determined based on the operating ratio of the cooling fan 26.

According to the present embodiment, when the cooling power of the compressor 21 is determined based on the operating ratio of the cooling fan 26, the following effect may be produced as compared to when the cooling power of the compressor 21 is determined based on the operating ratio of the compressor 21.

First, according to the present embodiment, since the ON and OFF operations of the compressor 21 are not repeated, the power consumption may be prevented from being largely increased in the procedure of turning on the compressor 21. In addition, in the state that the compressor 21 is turned off, noise may be prevented from being generated when the compressor 21 is turned on. In addition, the number of times of turning on and turning off the compressor is reduced, thereby reducing the possibility of the failure in the compressor 21.

Hereinafter, the modification of the first embodiment will be described.

According to the above embodiment, although the cooling power of the compressor 21 is determined based on the previous operating ratio and the current operating ratio of the cooling fan 26, the cooling power of the compressor 21 may be determined depending on the result of the comparison between the current operating ratio of the cooling fan and the reference operating ratio which is previously determined. The reference operating ratio may be stored in the memory 44.

In this case, in the method of controlling the refrigerator of FIGS. 3 to 5, steps S13 to S17 may be omitted. In addition, step S18 may be changed to step of changing the cooling power of the compressor 21 by the result of comparing the current operating ratio with the reference operating ratio, which is previously determined, (or a target operating ratio).

In addition, unless the refrigerator is turned off after step S19, the method may move to step S8 of FIG. 3 and the constant-temperature operation may be repeatedly performed.

That is, in the constant-temperature operating step, when the current operating ratio of the cooling fan 26 is calculated, the cooling power of the compressor 21 is determined by the result of comparison with the reference operating ratio stored in the memory 44 and the compressor 21 may be operated with the determined cooling power in a next operating period.

For example, when the absolute value of the difference between the previous operating ratio and the current operating ratio is less than the first reference value, the controller 50 may maintain the cooling power of the compressor 21 to be current cooling power. In other words, the controller 50 does not vary the cooling power of the compressor 21.

Alternatively when the absolute value of the difference between the previous operating ratio and the current operating ratio of the cooling fan 26 is equal to or greater than the first reference value, the cooling power of the compressor 21 may be increased or decreased.

For example, when the difference between the previous operating ratio and the current operating ratio is less than zero and the absolute value of the difference between the previous operating ratio and the current operating ratio is equal to or greater than the first reference value, the cooling power of the compressor 21 may be increased by the first level.

The reference operating ratio may be experimentally determined such that the temperature of the refrigerating compartment 112 is maintained within the temperature satisfaction range while the cooling power of the compressor 21 is operated with cooling power smaller than the intermediate cooling power without an external influence in the state that the door of the refrigerating compartment 112 is closed. The reference operating ratio may not be changed in the storage state of the memory 44 or may be varied depending on the type of a refrigerator or an outdoor environment (temperature).

For example, when the difference between the reference operating ratio and the current operating ratio is less than zero and the absolute value of the difference between the reference operating ratio and the current operating ratio is equal to or greater than the first reference value, the cooling power of the compressor 21 may be increased by the first level.

In the present embodiment, a plurality of reference values for comparison with the absolute value of the difference between the reference operating ratio and the current operating ratio may be set.

For example, when the difference between the reference operating ratio and the current operating ratio is less than zero and the absolute value of the difference between the reference operating ratio and the current operating ratio is equal to or greater than the second reference value which is greater than the first reference value, the cooling power of the compressor 21 may be increased by the second level.

Alternatively, when the absolute value of the difference between the reference operating ratio and the current operating ratio is equal to or greater than a third reference value which is greater than the second reference value, the cooling power of the compressor 21 may be increased by the third level.

For example, when the difference between the reference operating ratio and the current operating ratio is greater than zero and the absolute value of the difference between the reference operating ratio and the current operating ratio is equal to or greater than the second reference value which is greater than the first reference value, the cooling power of the compressor 21 may be decreased by the second level.

Alternatively, when the absolute value of the difference between the reference operating ratio and the current operating ratio is equal to or greater than a third reference value which is greater than the second reference value, the cooling power of the compressor 21 may be increased by the third level.

At this time, differences between the plurality of reference values may be equally or differently set.

For example, the first reference value may be set to E1, the second reference value may be set to 2*E1, and the third reference value may be set to 3*E1. Alternatively, the first reference value may be set to E2, the second reference value may be set to F*E2, and the third reference value may be set to F1*E2. At this time, F1 may have a greater value than F.

In addition, differences between the plurality of levels may be equally or differently set.

For example, the first level may be set to have a cooling power change value of G, the second level may be set to have a cooling power change value of 2*G and the third level may be set to have a cooling power change value of 3*G.

Alternatively, the first level may be set to have a cooling power change value of G1, the second level may be set to have a cooling power change value of G2 (greater than G1) instead of 2*G1, and the third level may be set to have a cooling power change value of G3 (greater than G2) instead of 3*G1.

According to the present embodiment, since the cooling power of the compressor 21 may be varied based on the result of the comparison between the reference operating ratio and the current operating ratio of the cooling fan 26, the cooling power of the compressor 21 may be adjusted without turning off the compressor 21, thereby preventing the power consumption from being increased due to the repeated ON/OFF operations of the compressor 21.

Hereinafter, the modification of the first embodiment will be described.

The controller 50 may maintain the cooling power of the compressor to be in a current state, or increase or decrease the cooling power, based on a first factor (a difference between a previous operating ratio of the cooling fan and a current operating ratio of the cooling fan 26) and a second factor (a difference between a reference operating ratio, which is previously determined, and a current operating ratio of the cooling fan 26) for adjusting the cooling power of the compressor 21.

In this modified example, steps S1 to S20 described in the first embodiment may be equally performed.

The controller 50 may determine whether the cooling power of the compressor 21 is increased, maintained or decreased based on the first factor, determine whether the cooling power of the compressor 21 is increased, maintained or decreased based on the second factor, and then finally determine whether the cooling power of the compressor 21 is increased, maintained or decreased based on a combination of the results.

For example, upon determining that the cooling power of the compressor 21 is maintained based on the first factor and determining that the cooling power of the compressor 21 is increased based on the second factor, the cooling power of the compressor 21 is finally increased.

Upon determining that the cooling power of the compressor 21 is maintained based on the first factor and determining that the cooling power of the compressor 21 is decreased based on the second factor, the cooling power of the compressor 21 is finally decreased.

Upon determining that the cooling power of the compressor 21 is maintained based on the first factor and the second factor, the cooling power of the compressor 21 is finally maintained.

Upon determining that the cooling power of the compressor 21 is increased based on the first factor and determining that the cooling power of the compressor 21 is maintained based on the second factor, the cooling power of the compressor 21 is finally increased.

Upon determining that the cooling power of the compressor 21 is decreased based on the first factor and determining that the cooling power of the compressor 21 is maintained based on the second factor, the cooling power of the compressor 21 is finally decreased.

Upon determining that the cooling power of the compressor 21 is increased based on the first factor and the second factor, the cooling power of the compressor 21 is finally increased.

Upon determining that the cooling power of the compressor 21 is decreased based on the first factor and the second factor, the cooling power of the compressor 21 is finally decreased.

Upon determining that the cooling power of the compressor 21 is decreased based on the first factor and determining that the cooling power of the compressor 21 is increased based on the second factor, the cooling power of the compressor 21 may be maintained, increased or decreased according to the level of the cooling power determined as being decreased based on the first factor and the level of the rotation speed determined as being increased based on the second factor.

Upon determining that the cooling power of the compressor 21 is increased based on the first factor and determining that the cooling power of the compressor 21 is decreased based on the second factor, the cooling power of the compressor 21 may be maintained, increased or decreased according to the level of the cooling power determined as being increased based on the first factor and the level of the cooling power determined as being decreased based on the second factor.

According to one embodiment of the present disclosure, as described above, the cooling power of the compressor 21 may be determined based on the operating ratio of the cooling fan 21. According to a modification, the operating ratio of the cooling fan may be formed by substituting the operating ratio of the cooling fan with the operating ratio of the damper. In other words, the cooling power of the cold air generator may be determined based on the operating ratio of the damper.

In addition, the output of the cold air transmission unit may be the output of the cooling fan or the opening angle of the damper.

According to an aspect, a method (control method) for controlling a refrigerator including a cold air generator to generate cold air to cool the storage compartment and a cold air transmission unit to transmit the cold air to the storage compartment may include intermittently operating the cold air generator with set cooling power, after the initial operating condition is satisfied.

The control method may additionally include operating the cold air transmission unit with the setting output after the initial operating condition is satisfied.

The control method may further include determining whether the temperature of the storage compartment reaches the lower limit temperature A2. The control method may further include reducing the output of the cold air transmission unit to be lower than the setting output after the temperature of the storage compartment reaches the lower limit temperature A2. The control method may further include continuously operating the cold air transmission unit with reference cooling power after the temperature of the storage compartment reaches the lower limit temperature A2.

The control method may further include operating the cold air transmission unit with the reference output, after the temperature of the storage compartment is equal to or greater than the first reference temperature C1 higher than the lower limit temperature. The control method may further include reducing the output of the cold air transmission unit to be lower than the reference output (for example, off step), after the temperature of the storage compartment is equal to or less than the second reference temperature C2 between the first reference temperature and the lower limit temperature. The control method may further include continuously operating the cold air generator with the reference cooling power, when the temperature of the storage compartment is equal to or less than the second reference temperature C2 between the first reference temperature and the lower limit temperature.

The control method may further include increasing the output of the cold air transmission unit to be higher than that in the previous level, when the temperature of the storage compartment is equal to or greater than the first reference temperature. The control method may further include continuously operating the cold air generator with the reference cooling power, when the temperature of the storage compartment is equal to or greater than the first reference temperature. The control method may further include decreasing the output of the cold air transmission unit to be lower than that in the previous level, when the temperature of the storage compartment is equal to or greater than the second reference temperature. The control method may further include continuously operating the cold air generator with the reference cooling power, when the temperature of the storage compartment is equal to or less than the second reference temperature.

The control method further includes calculating the operating ratio of the cold air transmission unit, based on the operating time (for example, ON time) in the state that the output of the cold air transmission unit is increased and the operating time (for example, OFF time) in the state that the output of the cold air transmission unit is decreased.

The control method further include determining, by the controller, the cooling power of the cold air generator, based on the difference between the previous operating ratio of the cold air transmission unit and the current operating ratio of the cold air transmission unit, in the state that the operating ratio of the cold air transmission unit is calculated at least two times. The control method may include operating by the controller, the cold air transmission unit with the determined output.

The initial operating condition may include at least one of the case that the refrigerator is powered on, the case that the starting condition of the operation corresponding to the door load of the refrigerator is satisfied, or the case that the condition of terminating the defrost operation of the refrigerator is satisfied (in other words, the starting condition of the operation is satisfied after defrosting).

The controller may determine the cooling power of the cold air generator based on a first factor which is a difference between a previous operating ratio of the cold air transmission unit and a current operating ratio of the cold air transmission unit, and a second factor which is a difference between a reference operating ratio, which is previously determined, and the current operating ratio of the cold air transmission unit.

The operating ratio of the cold air transmission unit may be determined based on (the operating time (for example, fan ON time) in the state that the output of the cold air transmission unit is increased)/(the operating time (fan ON time) in the state that the output of the cold air transmission unit is increased+the operating time (for example fan OFF time) in the state that the output of the cold air transmission unit is decreased.

The operating ratio of the cold air transmission unit may be determined through following Equation.

MV_{T}=MVₜ₋₁−(Kₚ(eₜ−eₜ₋₁)+Kᵢeₜ)

In this case, MV_{T} is the cooling power of the cold air generator in the current stage, MVₜ₋₁ is the cooling power of the cold air generator in the previous stage, Kₚ is a control constant of ‘P’, Kᵢ is a control constant of ‘I’, and et represents (target operating ratio of cold air transmission unit-operating ratio of cold air transmission unit in current stage), or eₜ₋₁ represents (target operating ratio of cold air transmission unit-operating ratio of cold air transmission unit in previous stage).

The cold air generator may be a compressor, and the cold air transmission unit may be a cooling fan which operates to provide cold air to the storage compartment or a damper which opens or closes a passage for providing the cold air to the storage compartment.

The refrigerator may include an evaporator, a first storage compartment, and a second storage compartment (for example, freezing compartment) maintained at a temperature lower than that of the first storage compartment. The evaporator and the cooling fan may be disposed closer to the second storage compartment rather than the first storage compartment. The refrigerator may additionally include a knob to adjust that cold air generated from the second storage compartment is transmitted to the first storage compartment.

According to another embodiment of the inventive concept, the operating ratio of the cooling fan may be formed by substituting the operating ratio of the cooling fan with a time at which the output of the cooling fan is maintained increased, as compared to that in the previous stage.

In other words, the cooling power of the cold air generator may be determined based on the time at which the output of the cooling fan is maintained increased, as compared to that in the previous stage. For example, the time at which the output of the cooling fan is maintained increased, as compared to that in the previous stage may be time at which the cooling fan is maintained in an ON state, when the cooling fan becomes turned on in the current stage after the cooling fan is turned off in the previous stage.

According to the modification, the operating ratio of the cooling fan may be formed by substituting the opening angle of the damper is maintained increased as compared to that in the previous stage. In other words, the cooling power of the cold air generator may be determined based on the time at which the opening angle of the damper is maintained increased, as compared to that in the previous stage. For example, when the damper becomes open after closed in the previous stage, time at which the opening angle of the damper is maintained increased, as compared to that in the previous stage, may time at which the damper is maintained open. In this case, the output of the cold air transmission unit may be the output of the cooling fan. The output of the cold air transmission unit may be the opening angle of the damper.

A method for controlling a refrigerator including a cold air generator to generate cold air for cooling the storage compartment, and a cold air transmission unit to transmit cold air to the storage compartment, may include immediately operating the cold air generator with the setting cooling power, after the initial operating condition is satisfied.

The control method may additionally include operating the cold air transmission unit with the setting output after the initial operating condition is satisfied. The control method may further include determining whether the temperature of the storage compartment reaches the lower limit temperature A2. The control method further include reducing the output of the cold air transmission unit to be lower than the setting output after the temperature of the storage compartment reaches the lower limit temperature A2.

The control method further include continuously operating the cold air generator with reference cooling power after the temperature of the storage compartment reaches the lower limit temperature A2.

The control method may further include operating the cold air transmission unit with the reference output, after the temperature of the storage compartment is equal to or greater than the first reference temperature C1 higher than the lower limit temperature. The control method may further include reducing the output of the cold air transmission unit to be lower than the reference output (for example, off step), after the temperature of the storage compartment is equal to or less than the second reference temperature C2 between the first reference temperature and the lower limit temperature. The control method may further include continuously operating the cold air generator with the reference cooling power, when the temperature of the storage compartment is equal to or less than the second reference temperature C2 between the first reference temperature and the lower limit temperature.

The control method may further include increasing (for example, an ON stage) the output of the cold air transmission unit to be higher than that in the previous level, when the temperature of the storage compartment is equal to or greater than the first reference temperature. The control method further includes continuously operating the cold air generator with reference cooling power when the temperature of the storage compartment is equal to or greater than the first reference temperature. The control method may further include increasing (for example, an ON stage) the output of the cold air transmission unit to be higher than that in the previous level, when the temperature of the storage compartment is equal to or less than the second reference temperature. The control method may further include continuously operating the cold air generator with the reference cooling power, when the temperature of the storage compartment is equal to or less than the second reference temperature.

The control method may further include calculating time at which the output of the cold air transmission unit is maintained increased (for example, ON time).

The control method may including determining, by the controller, the cooling power of the cold air generator, based on a difference between time at which the output of the cold air transmission unit is maintained increased in the previous stage and time at which the output of the cold air transmission unit is maintained increased (for example, ON time) in the current stage, in which at least two calculations are performed the time at which the output of the cold air transmission unit is maintained increased.

The control method may include operating by the controller, the cold air generator with the determined cooling power.

The controller may determine the cooling power of the cold air generator based on a first factor, which is a difference between the time (for example, fan ON time) at which the output of the cold air transmission unit is maintained increased in the previous stage and the time (for example, fan ON time) at which the output of the cold air transmission unit is maintained increased in the current stage, and a second factor, which is the difference between a reference time, which is previously determined, of the time (for example, fan ON time) at which the output of the cold air transmission unit is maintained increased in the previous stage, and the time (for example, ON time) at which the output of the cold air transmission unit is maintained increased in the current stage.

The operating ratio of the cold air transmission unit may be determined through following Equation.

MV_{T}=MVₜ₋₁−(Kₚ(eₜ−eₜ₋₁)+Kᵢeₜ)

In this case, MV_{T} is the cooling power of the cold air generator in the current stage, MVₜ₋₁ is the cooling power of the cold air generator in the previous stage, Kₚ is a control constant of ‘P’, Kᵢ is a control constant of ‘I’, and eₜ represents (target operating ratio of cold air transmission unit-operating ratio of cold air transmission unit in current stage), or eₜ₋₁ represents (target operating ratio of cold air transmission unit-operating ratio of cold air transmission unit in previous stage).

According to another embodiment of the inventive concept, the operating ratio of the cooling fan may be formed by substituting the operating ratio of the cooling fan with a time at which the output of the cooling fan is maintained increased, as compared to that in the previous stage.

In other words, the cooling power of the cold air generator may be determined based on the time at which the output of the cooling fan is maintained increased, as compared to that in the previous stage. For example, the time at which the output of the cooling fan is maintained decreased, as compared to that in the previous stage may be time at which the cooling fan is maintained in an OFF state, when the cooling fan becomes turned off in the current stage after the cooling fan is turned off in the previous stage.

According to the modification, the operating ratio of the cooling fan may be formed by substituting the opening angle of the damper is maintained decreased as compared to that in the previous stage. In other words, the cooling power of the cold air generator may be determined based on the time at which the opening angle of the damper is maintained decreased, as compared to that in the previous stage. For example, when the damper becomes closed after open in the previous stage, time at which the opening angle of the damper is maintained decreased, as compared to that in the previous stage, may time at which the damper is maintained closed. In this case, the output of the cold air transmission unit may be the output of the cooling fan. The output of the cold air transmission unit may be the opening angle of the damper.

A method for controlling a refrigerator including a cold air generator, which generates cold air to cool a storage compartment, and a cold air transmission unit which transmits the cold air to the storage compartment includes intermittently operating the cold air generator with the set power after the initial operating condition is satisfied.

The control method may additionally include operating the cold air transmission unit with the setting output after the initial operating condition is satisfied. The control method may further include determining whether the temperature of the storage compartment reaches the lower limit temperature A2. The control method further include reducing the output of the cold air transmission unit to be lower than the setting output after the temperature of the storage compartment reaches the lower limit temperature A2. The control method further include continuously operating the cold air generator with reference cooling power after the temperature of the storage compartment reaches the lower limit temperature A2.

The control method may further include operating the cold air transmission unit with the reference output, after the temperature of the storage compartment is equal to or greater than the first reference temperature C1 higher than the lower limit temperature. The control method may further include reducing the output of the cold air transmission unit to be lower than the reference output (for example, OFF step), after the temperature of the storage compartment is equal to or greater than the second reference temperature C2 between the first reference temperature and the lower limit temperature. The control method may further include continuously operating the cold air generator with the reference cooling power, when the temperature of the storage compartment is equal to or less than the second reference temperature C2 between the first reference temperature and the lower limit temperature.

The control method may further include increasing (for example, an ON stage) the output of the cold air transmission unit to be higher than that in the previous level, when the temperature of the storage compartment is equal to or greater than the first reference temperature. The control method may further include continuously operating the cold air generator with the reference cooling power, when the temperature of the storage compartment is equal to or greater than the first reference temperature. The control method may further include increasing (for example, an OFF stage) the output of the cold air transmission unit to be lower than that in the previous level, when the temperature of the storage compartment is equal to or greater than the second reference temperature. The control method may further include continuously operating the cold air generator with the reference cooling power, when the temperature of the storage compartment is equal to or less than the second reference temperature.

The control method may further include calculating time at which the output of the cold air transmission unit is maintained increased (for example, ON time).

The control method may including determining, by the controller, the cooling power of the cold air generator, based on a difference between time at which the output of the cold air transmission unit is maintained decreased in the previous stage and time at which the output of the cold air transmission unit is maintained decreased (for example, OFF time) in the current stage, in which at least two calculations are performed the time at which the output of the cold air transmission unit is maintained decreased (for example, OFF time). The control method may include operating by the controller, the cold air generator with the determined cooling power.

The controller may determine the cooling power of the cold air generator based on a first factor, which is a difference between the time at which the output of the cold air transmission unit is maintained decreased in the previous stage (for example, fan OFF time) and the time at which the output of the cold air transmission unit is maintained decreased in the current stage (for example, fan OFF time), and a second factor, which is the difference between a reference time, which is previously determined, of the time at which the output of the cold air transmission unit is maintained decreased in the previous stage, and time at which the output of the cold air transmission unit is maintained decreased in the current stage.

The operating ratio of the cold air transmission unit may be determined through the following Equation.

MV_{T}=MVₜ₋₁−(Kₚ(eₜ−eₜ₋₁)+Kᵢeₜ)

In this case, MV_{T} is the cooling power of the cold air generator in the current stage, MVₜ₋₁ is the cooling power of the cold air generator in the previous stage, Kₚ is a control constant of ‘P’, Kᵢ is a control constant of ‘I’, and eₜ represents (target operating ratio of cold air transmission unit-operating ratio of cold air transmission unit in current stage), or eₜ₋₁ represents (target operating ratio of cold air transmission unit-operating ratio of cold air transmission unit in previous stage).

According to an embodiment of the inventive concept, the method for controlling the refrigerator may include performing a control operation to determine the cooling power of the compressor, based on the temperature of the storage compartment per a unit time.

The controller of the refrigerator may determine the cooling power of the compressor based on the temperature of the storage compartment. The temperature of the storage compartment may be measured every unit time (which is preset). In this case, the cooling power of the compressor, which is one of the cooling unit, is adjusted depending on the change in the temperature of an object (that is, the storage compartment) to be cooled.

The unit time may be significantly short time. Accordingly, when the cooling power of the compressor is adjusted per unit time, the adjustment in the cooling power of the compressor may frequently occur. Accordingly, the power consumption of the compressor may be increased. In addition, the number of times of producing noise may be increased when the cooling power of the compressor is increased. In addition, the possibility of the failure of the compressor may be increased.

The output of the cooling fan (which may be a common fan in a plurality of storage compartments; a first cooling unit) may be adjusted based on the temperature of the storage compartment, and the cooling power of the compressor (second cooling unit) may be controlled to be determined based on the situation of adjusting the output of the cooling fan.

The controller of the refrigerator may determine the output of the cooling fan based on the temperature of the storage compartment. The controller may determine the cooling power of the compressor based on the operation of the determined cooling fan. The cooling fan is one of cooling units of the refrigerator. The cooling fan is another of cooling units of the refrigerator.

The controller of the refrigerator may determine the output of the first cooling unit based on the temperature of the storage compartment. The controller may determine the cooling power of the second cooling unit based on the operating information of the first cooling unit.

The controller of the refrigerator may perform a control operation such that the first cooling unit performs precooling for the storage compartment based on the temperature of the storage compartment. The controller may perform a control operation such that the second cooling unit cools the storage compartment based on the operating information of the first cooling unit. The operating information of the first cooling unit may include at least one of the operating ratio of the first cooling unit, time at which the output of the first cooling unit is maintained increased as compared to that in the previous stage, or time at which the output of the first cooling unit is maintained decreased as compared to that in the previous stage.

Determining, by the controller, the output of the first cooling unit may be different from determining, by the controller, the cooling power of the second cooling unit.

The output of the first cooling unit may be determined through another manner instead of PI controlling, and the cooling power of the second cooling unit may be determined through the PI controlling.

According to an embodiment of the inventive concept, determining the output of the cooling fan based on the temperature of the storage compartment may not be the PI controlling. In other words, when the temperature of the storage compartment reaches the first reference temperature C1, the controller may control the output of the cooling fan to be increased or turned on. In other words, when the temperature of the storage compartment reaches the second reference temperature C2, the controller may control the output of the cooling fan to be decreased or turned off.

Finally, although the temperature of the storage compartment is measured every unit time, which is preset, the output of the cooling fan, which is one of the cooling unit per unit time, may not be adjusted depending on the change in the temperature of the cooling target, that is, the storage compartment. Accordingly, the frequent adjustment of the output of the cooling fan may be reduced, so the power consumption of the cooling fan may be reduced. In addition, the number of times of producing noise when the output of the cooling fan is increased, may be reduced. In addition, the possibility of the failure of the cooling fan may be increased.

In addition, the cooling power of the compressor, which is another cooling unit, may not be immediately adjusted according to the temperature change of the storage chamber per unit time. Accordingly, the power consumption of the compressor may be reduced. In addition, the number of times of producing noise may be increased when the cooling power of the compressor is increased. In addition, the possibility of the failure of the cooling fan may be increased.

Meanwhile, the refrigerator operates in least two cycles between the first reference temperature C1 and the second reference temperature C2.

When the refrigerator operates in the two cycles, the controller may compare the operating ratio of the cooling fan in the previous stage with the operating ratio of the cooling fan in the current stage.

The controller may control the cooling power of the compressor to be adjusted based on the compared operation rate of the cooling fan. Determining the cooling power of the compressor based on the operating ratio of the cooling fan may be PI controlling.

According to another embodiment, determining the output of the cooling fan based on the temperature of the storage compartment may not be PI controlling. The output of the cooling fan may be determined based on the temperature of the storage compartment measured per unit time. In this case, the output of the cooling fan per unit time may be frequently adjusted. As described above, power consumption of the cooling fan may be increased, noise of the cooling fan may be increased, or the possibility of failure of the cooling fan may be increased. In addition, the cooling power of the compressor, which is another cooling unit, may not be immediately adjusted according to the temperature change of the storage chamber per unit time. Accordingly, the power consumption of the compressor may be reduced. In addition, the number of times of producing noise may be increased when the cooling power of the compressor is increased. In addition, the possibility of the failure of the cooling fan may be increased.

Meanwhile, the refrigerator operates in least two cycles between the first reference temperature C1 and the second reference temperature C2.

When the refrigerator operates in the two cycles, the controller may compare the operating ratio of the cooling fan in the previous stage with the operating ratio of the cooling fan in the current stage.

The controller may control the cooling power of the compressor to be adjusted based on the compared operation rate of the cooling fan. Determining the cooling power of the compressor based on the operating ratio of the cooling fan may be PI controlling.

According to the inventive concept, a temperature stabilization duration may be included. When the refrigerator enters the continuous operation section, the controller continuously varies the output or cooling power without turning off.

When the entrance into the step of calculating the operating ratio of the cooling fan is made without the temperature stabilization section after the initial operating condition, the difference between the operating ratio calculated in step 1 of calculating the operating ratio of the cooling fan and the operating ratio calculated in step 2 of calculating the operating ratio of the cooling may represent a significantly larger value or a significantly smaller value. An inadequate cooling power may be determined in the step of varying the cooling power of the compressor based on the operating ratio of the cooling fan.

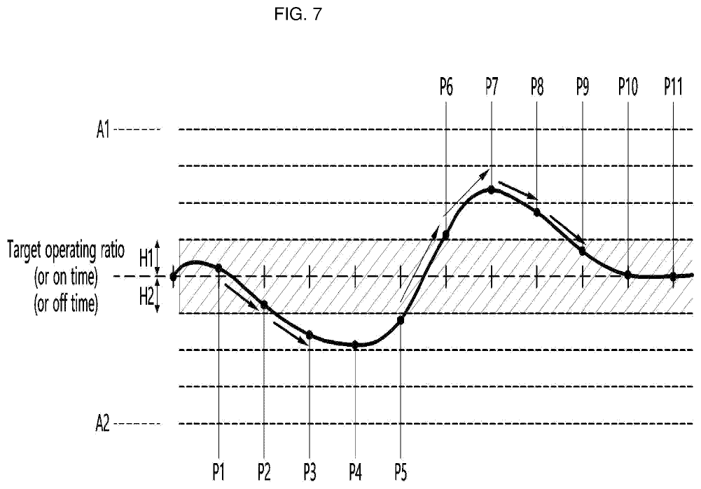

FIG. 7 is a graph illustrating the variation in an operating ratio of a cold air transmission unit and an output control of the cold air generator.

In FIGS. 7, P1 to P11 refer to the outputs of the cold air generator for each unit time.

P2 is smaller than P1, and P3 is smaller than P2. P4 is smaller than P3, and P5 is smaller than P4. P6 is greater than P5, P7 is greater than P6, and P8 is equal to P7. P9 is smaller than P8, and P10 and P11 are the same as P9.

Referring to FIG. 7, a method for controlling a refrigerator including a cold air generator, which generates cold air to cool a storage compartment, and a cold air transmission unit which transmits the cold air to the storage compartment may include operating the cold air generator for a specific time with an output previously determined.

The control method may include determining, by the controller, the output of the cold air generator based on the current temperature of the storage compartment, which is sensed by the temperature sensor, when the specific time is elapsed. The control method may include operating by the controller, the cold air generator with the determined output.

When the absolute value of the difference value between the operating ratio (or ON time or OFF time) of the cold air transmission unit in the previous step and the operating ratio (or ON time or OFF time) of the cold air transmission unit in the current step is smaller than the first reference value, and when the difference between the target operating ratio (or ON time or OFF time) of the cold air transmission unit and the operating ratio (or ON time or OFF time) of the cold air transmission unit in the current stage is equal to or greater than the first upper limit reference value, the controller may determine the output of the cold air transmission unit to be increased.

When the difference between the target operating ratio (or ON time or OFF time) of the cold air transmission unit and the operating ratio (or ON time or OFF time) of the cold air transmission unit in the current stage is greater than the first lower limit reference value, the controller may perform a control operation such that the output of the cold air supply unit is determined to be reduced (for example, see that the output of the cold air generator is reduced from P2 to P3).

In addition, when the absolute value of the difference value between the operating ratio (or ON time or OFF time) of the cold air transmission unit in the previous step and the operating ratio (or ON time or OFF time) of the cold air transmission unit in the current step is greater than the first reference value, and when the difference between the target operating ratio (or ON time or OFF time) of the cold air transmission unit and the operating ratio (or ON time or OFF time) of the cold air transmission unit in the current stage is equal to or greater than the first upper limit reference value, the controller may determine the output of the cold air generator to be increased.

In addition, when the absolute value of the difference value between the operating ratio (or ON time or OFF time) of the cold air transmission unit in the previous step and the operating ratio (or ON time or OFF time) of the cold air transmission unit in the current step is greater than the first reference value, and when the difference between the target operating ratio (or ON time or OFF time) of the cold air transmission unit and the operating ratio (or ON time or OFF time) of the cold air transmission unit in the current stage is equal to or greater than the first lower limit reference value, the controller may determine the output of the cold air generator to be decreased.

When the difference between the target operating ratio (or ON time or OFF time) of the cold air transmission unit and the operating ratio (or ON time or OFF time) of the cold air transmission unit in the current stage is less than the first upper limit reference value or the first lower limit reference value, the controller may perform a control operation such that the output of the cold air generator is maintained.

While the cold air generator is operated with the output decreased or increased as the controller determines the output of the cold air generator to be decreased or increased, when the absolute value of the difference value between the operating ratio (or ON time or OFF time) of the cold air transmission unit in the previous step and the operating ratio (or ON time or OFF time) of the cold air transmission unit in the current step is less than the first reference value, and when the absolute value of the difference between the target operating ratio (or ON time or OFF time) of the cold air transmission unit and the operating ratio (or ON time or OFF time) of the cold air transmission unit in the current stage is equal to or greater than the first upper limit reference value or the first lower limit reference value, the controller may determine the output of the cold air generator to be decreased or increased again (the output is decreased/increased again when the same condition is satisfied after a specific period of time is elapsed).

According to another embodiment of the inventive concept, the operating ratio of the cooling fan may be formed by substituting the operating ratio of the cooling fan with a time at which the output of the cooling fan is maintained increased, as compared to that in the previous stage.

According to still another embodiment of the inventive concept, the operating ratio of the cold air transmission unit may be formed by substituting the operating ratio of the cold air transmission unit with a time at which the output of the cold air transmission unit is maintained decreased as compared to that in the previous step.

The reference values (which are determined through an output variation table based on the variation (previous value-current value) of the temperatures measured at specific time intervals) may be set at equal intervals or irregular intervals.

The specific time intervals may be equal time intervals, or irregular time intervals. For example, the interval in a satisfaction range may be greater than the interval in a dissatisfaction range.

The upper limit reference value or the lower limit reference value may be set to be equal to or different from the reference value.

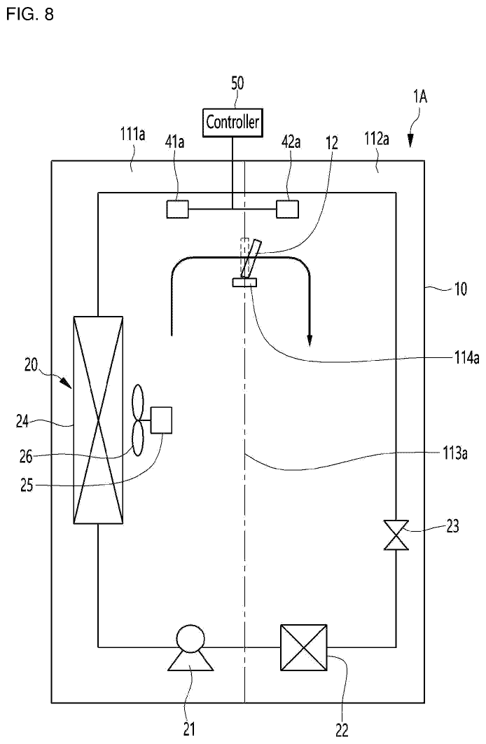

FIG. 8 is a view schematically illustrating the configuration of the refrigerator according to a second embodiment of the present disclosure.

Referring to FIG. 8, the refrigerator 1A according to the second embodiment of the present disclosure may include a cabinet 10, in which a freezing compartment 111a and a refrigerating compartment 112a are formed, and doors (not shown) coupled to the cabinet 10 to open and close the freezing compartment 111a and the refrigerating compartment 112a.

The freezing compartment 111a and the refrigerating compartment 112a may be horizontally or vertically partitioned by a partitioning wall 113a in the cabinet 10. A cold air hole may be formed in the partitioning wall 113a, and a damper 12 may be installed in the cold air hole to open or close the cold air hole.

The refrigerator 1 may further include a freezing cycle 20 for cooling the freezing compartment 111a and/or the refrigerating compartment 112a.

The freezing cycle 20 may be equal to that of the first embodiment and thus a detailed description thereof will be omitted.

In the freezing cycle 20, the evaporator 24 may include a freezing compartment evaporator.

The refrigerator 1 may include a cooling fan 26 for enabling air to flow toward the evaporator 24 for cold air circulation of the freezing compartment 111a, and a fan driving unit 25 for driving the cooling fan 26.

In the present embodiment, the compressor 21 and the cooling fan 26 need to operate to supply cold air to the freezing compartment 111a, and the compressor 21 and the cooling fan 26 need to operate and the damper 12 needs to be open to supply cold air to the refrigerating compartment 112a. In this case, the damper 12 may operate by a damper driving unit 114a.

The compressor 21, the cooling fan 26 (or the fan driving unit 25) and the damper 12 (or the damper motor 114a) may be referred to as a “cooling unit” which operates to cool the storage compartment. The cooling unit may include one or more of a cold air generator and a cold air transmission unit (cold air transmitter).

In the present embodiment, the compressor 21 may be called a cold air generator and the cooling fan 26 and the damper 12 may be called a cold air transmission unit.

In the present disclosure, the output of the cold air generator may mean the cooling power of the compressor 21 and the output of the cold air transmission unit may mean the rotation speed of the cooling fan 26 and/or the opening angle of the damper 12.

When the cold air transmission unit is the cooling fan 26, the operating ratio of the cooling fan 26 may mean a ratio of an ON time to a sum of the ON time and the OFF time of the cooling fan 26 in one ON/OFF period of the cooling fan 26.

In the present embodiment, a state in which the damper 12 is closed is defined as a state in which the cold air transmission unit is turned off and a state in which the damper 12 is open is defined as a state in which the cold air transmission unit is turned on.

When the cold air transmission unit is the damper 12, the operating ratio of the damper may mean a ratio of the opening time of the damper 12 to a sum of one closing time of the damper 12 and one opening time of the damper 12.

The refrigerator 1A may further include a freezing compartment temperature sensor 41a for detecting the temperature of the freezing compartment 111a, a freezing compartment temperature sensor 42a for detecting the temperature of the refrigerating compartment 112a, and a controller 50 for controlling the cold air generator based on the temperatures detected by the temperature sensors 41a and 42a.

The controller 50 may control one or more of the compressor 21 and the cooling fan 26 such that the temperature of the freezing compartment 111a is maintained at a set temperature (or a target temperature).

The controller 50 may control the output of one or more of the compressor 21, the cooling fan 26 and the damper 12 in order to maintain the temperature of the refrigerating compartment 112a at the set temperature.

For example, the cooling power of the compressor 21 may be controlled based on the operating ratio of the cooling fan 26 or the operating ratio of the damper 12 with the same pattern as that in the control method described in the first embodiment.

For example, when the refrigerator 1 is turned on, the controller 50 may perform preliminary operation for constant temperature control. For example, the controller 50 may perform control such that the compressor 21 operates with set cooling power and the cooling fan 26 operates at a set speed. In addition, the controller 50 may perform control such that the damper 12 is opened at a set angle.

The set cooling power of the compressor 21 may be, for example, maximum cooling power or cooling power close to the maximum cooling power, such that the temperature of the refrigerating compartment 112a rapidly drops. In addition, the set speed of the cooling fan 26 may be, for example, a maximum speed or a speed close to the maximum speed In addition, the opening angle of the damper 12 may be a maximum angle or an angle close to the maximum angle.

When the compressor 21 and the cooling fan 26 operate and the damper 12 is opened at the set angle, the temperature of the refrigerating compartment 112a drops.

Upon determining that the temperature of the refrigerating compartment 112a reaches the lower limit temperature A2, the controller 50 may perform control to perform the temperature stabilization operation.

For example, the controller 50 may perform control such that the compressor 21 operates with the reference cooling power. The reference cooling power may be less than the intermediate cooling power between the maximum cooling power and the minimum cooling power of the compressor 21.

In addition, the controller 50 may change the opening angle of the damper 12 such that the damper 12 is closed or the opening angle of the damper 12 becomes a limited angle. The limited angle may be equal to or greater than the minimum angle of the damper 12, for example.

When the damper 12 is closed, the temperature of the refrigerating compartment 112a may increase.

The controller 50 may determine whether the temperature of the refrigerating compartment 112a is equal to or greater than the first reference temperature during the operation of the compressor 21.

The controller 50 may set the open angle of the damper 12 to be a first reference angle, upon determining that the temperature of the refrigerating compartment 112a is equal to or greater than the first reference temperature.

In the present embodiment, the first reference angle may be greater than the limited angle.

For example, when the damper 12 is opened at the first reference angle, the first reference angle may be set to decrease the temperature of the refrigerating compartment 112a.

Since the amount of cold air supplied to the refrigerating compartment 112a when the damper 12 is opened at the first reference angle is greater than that of cold air supplied to the refrigerating compartment 112a when the damper 12 is opened at the limited angle, the temperature of the refrigerating compartment 112a may decrease.

The first reference angle may be a fixed angle. Alternatively, the first reference angle may be changed once or more.

When the first reference angle is changed once or more, the first reference angle may be changed from the first angle to the second angle less than the first angle.

When the damper 12 is opened at a first angle, the amount of cold air supplied to the refrigerating compartment 112a is large and thus the temperature decreasing speed of the refrigerating compartment 112a may increase.

After the temperature of the refrigerating compartment 112a decreases to some extent, the opening angle of the damper 12 may decrease to a second angle, thereby reducing the temperature decreasing speed of the refrigerating compartment 112a. In this case, it is possible to reduce the temperature change range of the refrigerating compartment 112a per unit time.

At this time, a time when the opening angle of the damper 12 is changed from the first angle to the second angle may be determined by a time or based on the temperature of the refrigerating compartment 112a.

For example, when the damper 12 is opened at a first angle and a set time has elapsed, the damper 12 may be opened at a second angle.

Alternatively, when the temperature of the refrigerating compartment 112a reaches the third reference temperature between the first reference temperature and the second reference temperature in the state that the damper 12 is opened at a first angle, the damper 12 may be open at the second angle.

When the temperature of the refrigerating compartment 112a is equal to or less than the second reference temperature, the controller 50 may perform control to perform constant-temperature operation.

The controller 50 may perform control to repeat operation of closing and then opening the damper 12 in the constant-temperature operating step.

In the present embodiment, a period in which the damper 12 is closed, opened and closed again may be referred to as one operating period.

The controller 50 may calculate the operating ratio of the damper 12 for each operating cycle during two operating cycles and may determine the cooling power of the compressor 21 based on the calculated two operating ratios, in the constant temperature operation step. The controller 50 may operate the compressor 21 with the determined cooling power in a next operating cycle.

When the temperature of the refrigerating compartment 112a is equal to or less than the second reference temperature, the controller 50 performs control to close the damper 12 in a state in which operation of the compressor 21 is maintained.

When the damper 12 is closed, the temperature of the refrigerating compartment 112a may increase. The controller 50 may perform control to open the damper 12 at a second reference angle, upon determining that the temperature of the refrigerating compartment 112a is equal to or greater than the first reference temperature.

When the damper 12 is opened at the second reference angle, the temperature of the refrigerating compartment 112a may drop.

The second reference angle may be equal to or different from the first reference angle.

The second reference angle may be fixed or changed once or more like the first reference angle. Change in second reference angle may be equal to change in the first reference angle and thus a detailed description thereof will be omitted.

In a state in which the damper 12 is opened at the second reference angle, upon determining that the temperature of the refrigerating compartment 112a becomes equal to or less than the second reference temperature, the controller 50 may calculate the operating ratio of the damper 12 based on the closing time and opening time of the damper 12. The calculated operating ratio of the damper 12 may be stored in the memory 44.

Upon determining that the temperature of the refrigerating compartment 112a becomes equal to or less than the second reference temperature, the controller 50 may perform control to close the damper 12 in a state of maintaining operation of the compressor 21.

When the damper 12 is closed, the temperature of the refrigerating compartment 112a may increase. In a state in which the damper 12 is closed, upon determining that the temperature of the refrigerating compartment 112a becomes equal to or greater than the first reference temperature, the controller 50 may perform control such that the damper 12 is opened at a third reference angle. When the damper 12 is opened at the third reference angle, the temperature of the refrigerating compartment 112a may drop.

The third reference angle may be equal to one or more of the first reference angle and the second reference angle or may be different from the first reference angle and the second reference angle.

The third reference angle may be fixed or changed once or more like the first reference angle. Change in third reference angle may be equal to change in the first reference angle and thus a detailed description thereof will be omitted.

In a state in which the damper 12 is opened at the third reference angle, upon determining that the temperature of the refrigerating compartment 112a becomes equal to or less than the second reference temperature, the controller 50 may calculate the operating ratio of the damper 12 based on the closing time and opening time of the damper 12. The calculated operating ratio of the damper 12 may be stored in the memory 44.

That is, the operating ratio of the damper 12 may be calculated for each operating period and stored in the memory 44.

When a current operating ratio is calculated, the controller 50 may determine the cooling power of the compressor 21 by comparing the previous operating ratio with the current operating ratio. The controller 50 may operate the compressor 21 with the determined cooling power.

In other words, the controller 50 may perform a control operation such that the compressor 21 is operated with the determined cooling power in a next operating cycle.

A described in the description about the first embodiment, the controller 50 may determine the cooling power of the compressor 21 by comparing the previous operating ratio with the current operating ratio of the cooling fan 50.

For another example, the controller 50 may determine the cooling power of the compressor 21 by comparing the reference operating ratio with the current operating ratio of the damper 12.

For another example, the controller 50 may maintain the cooling power of the compressor 21 to be in the current state, or increase, or decrease the cooling power of the compressor 21, based on a first factor, (which is the difference between the previous operating ratio and the current operating ratio of the damper 12) to adjust the cooling power of the compressor 21 and a second factor (which is the difference between the reference operating ratio and the current operating ratio of the damper 12). Since the method for determining the cooling power of the compressor 21 based on the first factor and the second factor is the same in the description in the first embodiment, the details thereof will be omitted.

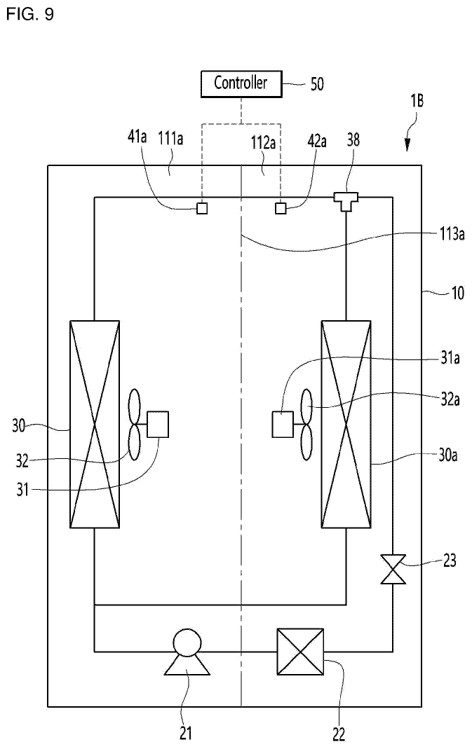

FIG. 9 is a view schematically showing the configuration of a refrigerator according to a third embodiment of the present disclosure.

Referring to FIG. 9, the refrigerator 1B according to the third embodiment of the present disclosure may include a cabinet 10, in which a freezing compartment 111a and a refrigerating compartment 112b are formed, and doors (not shown) coupled to the cabinet 10 to open and close the freezing compartment 111a and the refrigerating compartment 112a.

The freezing compartment 111a and the refrigerating compartment 112a may be horizontally or vertically partitioned by a partitioning wall 113a in the cabinet 10.

The refrigerator 1B may further include a condenser 22, an expansion member 23, a freezing compartment evaporator 30 (or a first evaporator) for cooling the freezing compartment 111a and a refrigerating compartment evaporator 30a (or a second evaporator) for cooling the refrigerating compartment 112a.

The refrigerator 1B may include a switch valve 38 for enabling the refrigerant, which has passed through the expansion member 23, to flow to any one of the freezing compartment evaporator 30 and the refrigerating compartment evaporator 30a.

In the present embodiment, a state in which the switch valve 38 operates such that the refrigerant flows to the freezing compartment evaporator 30 may be referred to as a first state. In addition, a state in which the switch valve 38 operates such that the refrigerant flows to the refrigerating compartment evaporator 30a may be referred to as a second state. The switch valve 38 may be a three-way valve, for example.

The switch valve 38 may selectively open any one of a first refrigerant passage connected such that refrigerant flows between the compressor 21 and the refrigerating compartment evaporator 30a and a second refrigerant passage connected such that refrigerant flows between the compressor 21 and the freezing compartment evaporator 30. By the switch valve 38, cooling of the refrigerating compartment 112a and cooling of the freezing compartment 111a may be alternately performed.

The refrigerator 1B may include a freezing compartment fan 32 (which may be referred to as a first fan) for blowing air to the freezing compartment evaporator 30, a first motor 31 for rotating the freezing compartment fan 32, a refrigerating compartment fan 32a (which may be referred to as a second fan) for blowing air to the refrigerating compartment evaporator 30a and a second motor 31a for rotating the refrigerating compartment fan 32a.

In the present embodiment, a series of cycles in which refrigerant flows through the compressor 21, the condenser 22, the expansion member 23 and the freezing compartment evaporator 30 may be referred to as a “freezing cycle” and a series of cycles in which refrigerant flows through the compressor 21, the condenser 22, the expansion member 23 and the refrigerating compartment evaporator 30a may be referred to as a “refrigerating cycle”.

“Operation of the refrigerating cycle” mean that the compressor 21 is turned on, the refrigerating compartment fan 32a is rotated, and the refrigerant flowing through the refrigerating compartment evaporator 30a exchanges heat with air while the refrigerant flows through the refrigerating compartment evaporator 30a by the switch valve 38.

“Operation of the freezing cycle” mean that the compressor 21 is turned on, the freezing compartment fan 32 is rotated, the refrigerant flowing through the freezing compartment evaporator 30 exchanges heat with air while the refrigerant flows through the freezing compartment evaporator 30 by the switch valve 38.

Although one expansion member 23 is located at the upstream side of the switch valve 38 in the above description, a first expansion member is provided between the switch valve 38 and the freezing compartment evaporator 30, and a second expansion member is provided between the switch valve 38 and the refrigerating compartment evaporator 30a.

In another example, the switch valve 38 may not be used, a first valve may be provided at the inlet side of the freezing compartment evaporator 30, and a second valve may be provided at the inlet side of the refrigerating compartment evaporator 30a. The first valve may be turned on and the second valve may be turned off during operation of the freezing cycle and the first valve may be turned off and the second valve may be turned on during operation of the refrigerating cycle.

The refrigerating compartment fan and the compressor may be referred to as a first cooling unit for cooling a first storage compartment and a freezing compartment fan and the compressor may be referred to as a second cooling unit for cooling a second storage compartment.

The refrigerator 1B may include a freezing compartment temperature sensor 41a for detecting the temperature of the freezing compartment 111a, a refrigerating compartment temperature sensor 42a for detecting the temperature of the refrigerating compartment 112a, an input unit (not shown) for inputting the respective target temperatures (or set temperatures) of the freezing compartment 111a and the refrigerating compartment 112a, and a controller 50 for controlling a cooling cycle (including the freezing cycle and the refrigerating cycle) based on the input target temperatures and the temperatures detected by the temperature sensors 41a and 42a.

In addition, in the present disclosure, a temperature higher than the set temperature of the refrigerating compartment 112a may be referred to as a first refrigerating compartment reference temperature and a temperature lower than the set temperature of the refrigerating compartment 112a may be referred to as a second refrigerating compartment reference temperature. In addition, a range between the first refrigerating compartment reference temperature and the second refrigerating compartment reference temperature may be referred to as a refrigerating compartment set temperature range.

In the present disclosure, a temperature higher than the set temperature of the freezing compartment 111a is referred to as a first freezing compartment reference temperature, and a temperature lower than the set temperature of the freezing compartment 111a may be a second freezing compartment reference temperature. In addition, a range between the first freezing compartment reference temperature and the second freezing compartment reference temperature may be referred to as a freezing compartment set temperature range.

In the present embodiment, a user may set the respective target temperatures of the freezing compartment 111a and the refrigerating compartment 112a.

In the present embodiment, the controller 50 may perform control such that a refrigerating cycle, a freezing cycle and a pump-down cycle configure one operating period. That is, the controller 50 may operate the cycle while continuously operating the compressor 21 without stopping.

In the present embodiment, the pump-down operation means operation of operating the compressor 21 to collect refrigerant remaining in each evaporator in the compressor 21 in a state in which supply of the refrigerant to all a plurality of evaporators is prevented.

The controller 50 operates the refrigerating cycle, and operates the freezing cycle when the stop condition of the refrigerating cycle is satisfied. When the stop condition of the freezing cycle is satisfied while the freezing cycle operates, the pump-down operation may be performed. When the pump-down operation is completed, the refrigerating cycle may operate again.

In the present embodiment, when the stop condition of the refrigerating cycle is satisfied, cooling of the refrigerating compartment may be regarded as being completed. In addition, when the stop condition of the freezing cycle is satisfied, cooling of the freezing compartment may be regarded as being completed.

At this time, in the present disclosure, the stop condition of the refrigerating cycle may be the start condition of the freezing cycle.

In the present embodiment the pump-down operation may be omitted under a special condition. In this case, the refrigerating cycle and the freezing cycle may alternately operate. The refrigerating cycle and the freezing cycle may configure one operating period.

In one operating period, the operating ratio of the refrigerating compartment fan 32a may be determined.

For example, in one operating period, when the refrigerating cycle operates, the refrigerating compartment fan 32a may be turned on, and, when the freezing cycle operates, the refrigerating compartment fan 32a may be turned off. Accordingly, the operating ratio of the refrigerating compartment fan 32a which is a ratio of the ON time of the refrigerating compartment fan 32a to a sum of the ON time and OFF time of the refrigerating compartment fan 32a may be determined.

The controller 50 may determine the cooling power of the compressor 21 during the freezing cycle based on the determined operating ratio of the freezing compartment fan 32a.

As described above in the first embodiment, the controller 50 may compare the previous operating ratio of the refrigerating compartment fan 32a with the current operating ratio of the refrigerating compartment fan 32a and determine the cooling power of the compressor 21 during operation of the refrigerating cycle.

In another example, the controller 50 may compare the reference operating ratio of the refrigerating compartment fan 32a with the current operating ratio of the refrigerating compartment fan 32a and determine the cooling power of the compressor 21 during operation of the refrigerating cycle.

In another example, the controller 50 may maintain the cooling power of the compressor 21 in the current state or may increase or decrease the cooling power of the compressor 21, based on a first factor (the difference between the previous operating ratio of the refrigerating compartment fan and the current operating ratio of the refrigerating compartment fan) and a second factor (the difference between the reference operating ratio and the current operating ratio of the refrigerating compartment fan) for adjusting the cooling power of the compressor 21.

In addition, in one operating period, the operating ratio of the freezing compartment fan 32 may be determined.

For example, in one operating period, when the freezing cycle operates, the freezing compartment fan 32 may be turned on, and, when the refrigerating cycle operates, the freezing compartment fan 32 may be turned off. Accordingly, the operating ratio of the freezing compartment fan 32 which is a ratio of the ON time of the freezing compartment fan 32 to a sum of the ON time and OFF time of the freezing compartment fan 32 may be determined.

The controller 50 may determine the cooling power of the compressor 21 during the freezing cycle based on the determined operating ratio of the freezing compartment fan 32.

As described above in the first embodiment, the controller 50 may compare the previous operating ratio of the freezing compartment fan 32 with the current operating ratio of the freezing compartment fan 32 and determine the cooling power of the compressor 21 during operation of the freezing cycle.

In another example, the controller 50 may compare the reference operating ratio of the freezing compartment fan 32 with the current operating ratio of the freezing compartment fan 32 and determine the cooling power of the compressor 21 during operation of the freezing cycle.

In another example, the controller 50 may maintain the cooling power of the compressor 21 in the current state or may increase or decrease the cooling power of the compressor 21, based on a first factor (the difference between the previous operating ratio of the freezing compartment fan and the current operating ratio of the freezing compartment fan) and a second factor (the difference between the reference operating ratio and the current operating ratio of the freezing compartment fan) for adjusting the cooling power of the compressor 21.

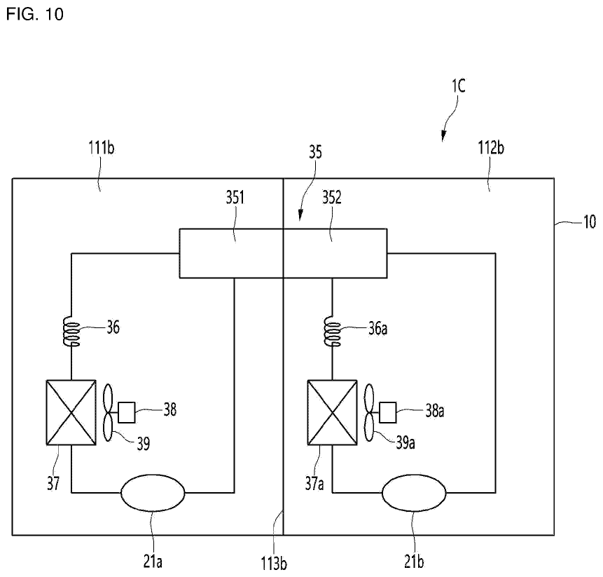

FIG. 10 is a view schematically showing the configuration of a refrigerator according to a fourth embodiment of the present disclosure.

Referring to FIG. 10, the refrigerator 1C according to the fourth embodiment of the present disclosure may include a cabinet 10, in which a freezing compartment 111b and a refrigerating compartment 112b are formed, and doors (not shown) coupled to the cabinet 10 to open and close the freezing compartment 111b and the refrigerating compartment 112b.

The freezing compartment 111b and the refrigerating compartment 112b may be horizontally or vertically partitioned by a partitioning wall 113b in the cabinet 10.

In addition, the refrigerator 1C may include a cooling cycle for cooling the freezing compartment 111b and the refrigerating compartment 112b.

The cooling cycle may include a freezing cycle for cooling the freezing compartment 111b and a refrigerating cycle for cooling the refrigerating compartment 112b.

The refrigerating cycle may include a freezing compartment compressor 21a (or a first compressor), a condenser 35, a first expansion member 36, a first evaporator 37 and a freezing compartment fan 39.

The freezing compartment fan 39 may rotate by a first motor 38. The freezing compartment fan 39 may blow air toward the first evaporator 37 for cold air circulation of the freezing compartment 111b.

In the present embodiment, the freezing compartment compressor 21a and the freezing compartment fan 39 may be referred to as a “freezing compartment cooling unit” for cooling the freezing compartment 111b.

The refrigerating cycle may include a refrigerating compartment compressor 21b (or a second compressor), a condenser 35, a second expansion member 36a, a second evaporator 37a and a refrigerating compartment fan 39a.

The refrigerating compartment fan 39a may rotate by a second motor 38a. The refrigerating compartment fan 39a may blow air toward the second evaporator 37a for cold air circulation of the refrigerating compartment 112b.

In the present embodiment, the refrigerating compartment compressor 21b and the refrigerating compartment fan 39a may be referred to as a “refrigerating compartment cooling unit” which operates to cool the refrigerating compartment 112b.

At this time, the condenser 35 configures one heat exchanger and is divided into two parts such that refrigerant flows. That is, refrigerant discharged from the first compressor 21a may flow to a first part 351 of the condenser 35 and refrigerant discharged from the second compressor 21b may flow to a second part 352 of the condenser 35. A condenser pin for the first part 351 and a condenser pin for the second part 352 may be connected to increase condensation efficiency of the condenser.

Compared to the case where two separate condensers are installed in a machine room, it is possible to increase the condensing efficiency of the condenser while reducing the installation space of the condenser. Accordingly, the first part 351 may be referred to as a first condenser and the second part 352 may be referred to as a second condenser.

The refrigerator 1C may further include a controller for controlling the cooling cycle based on the temperatures of the freezing compartment 111b and/or the refrigerating compartment 112b input through an input unit (not shown) and the temperatures detected by a freezing compartment temperature sensor and/or a refrigerating compartment temperature sensor (not shown).

In the present embodiment, a temperature higher than the target temperature of the freezing compartment 111b is referred to as a first freezing compartment reference temperature, and a temperature lower than the target temperature of the freezing compartment 111b may be referred to as a second freezing compartment reference temperature. In addition, a range between the first freezing compartment reference temperature and the second freezing compartment reference temperature may be referred to as a freezing compartment set temperature range.

In the present embodiment, the controller performs control such that the temperature of the freezing compartment 111b is maintained in the set temperature range. At this time, control to maintain the temperature of the freezing compartment 111b in the set temperature range is referred to as constant temperature control of the freezing compartment.

In addition, in the present embodiment, a temperature higher than the target temperature of the refrigerating compartment 112b is referred to as a first refrigerating compartment reference temperature, and a temperature lower than the target temperature of the refrigerating compartment 112b may be referred to as a second refrigerating compartment reference temperature. In addition, a range between the first refrigerating compartment reference temperature and the second refrigerating compartment reference temperature may be referred to as a refrigerating compartment set temperature range.

In the present embodiment, the controller performs control such that the temperature of the refrigerating compartment 112b is maintained in the set temperature range. At this time, control to maintain the temperature of the refrigerating compartment 112b in the set temperature range is referred to as constant temperature control of the refrigerating compartment.

The cooling cycle for the freezing compartment 111b and the refrigerating compartment 112b may configure respective cooling cycles such that the cooling unit independently operates according to the first reference temperature and the second reference temperature of the freezing compartment 111b and the first reference temperature and the second reference temperature of the refrigerating compartment 112b.

For example, the refrigerating cycle may stop, and the freezing cycle may operate for constant temperature control of the freezing compartment 111b. For constant temperature control of the freezing compartment 111b, the freezing compartment compressor 21a and the freezing compartment fan 39 may operate.

When the refrigerating cycle operates, the temperature of the freezing compartment 111b drops. In contrast, in a state in which the refrigerating cycle is stopped, the temperature of the refrigerating compartment 112b rises.

During operation of the refrigerating cycle, upon determining that the detected temperature of the refrigerating compartment reaches the first refrigerating compartment reference temperature, the controller operates the refrigerating cycle. That is, in order to reduce the temperature of the refrigerating compartment 112b, the controller operates the refrigerating compartment compressor 21b and the refrigerating compartment fan 39a.

At least some periods in which the refrigerating cycle operates, the freezing compartment compressor 21a and the freezing compartment fan 39 may be turned off.

At least some periods in which the freezing cycle operates, the refrigerating compartment compressor 21b and the refrigerating compartment fan 39a may be turned off.

When the operation condition of the refrigerating cycle is satisfied during operation of the refrigerating cycle, the controller may operate the freezing cycle.

The freezing compartment fan 39 may be repeatedly turned on and off by repetition of operation of the refrigerating cycle and operation of the refrigerating cycle, and the refrigerating compartment fan 39a is also repeatedly turned on and off.

The controller may calculate the operating ratio of the freezing compartment fan 39 using the ON time and OFF time of the freezing compartment fan 39. In addition, the controller may calculate the operating ratio of the refrigerating compartment fan 39a using the ON time and OFF time of the refrigerating compartment fan 39a.

The controller may determine the cooling power of the freezing compartment compressor 21a during the freezing cycle based on the operating ratio of the freezing compartment fan 39.

As described above in the first embodiment, the controller may compare the previous operating ratio of the freezing compartment fan 39 with the current operating ratio of the freezing compartment fan 39 and determine the cooling power of the freezing compartment compressor 21a during operation of the refrigerating cycle.

In another example, the controller may compare the reference operating ratio of the freezing compartment fan 39 with the current operating ratio of the freezing compartment fan 39 and determine the cooling power of the freezing compartment compressor 21a during operation of the freezing cycle.

In another example, the controller may maintain the cooling power of the freezing compartment compressor 21a in the current state or may increase or decrease the rotation speed of the freezing compartment fan 39, based on a first factor (the difference between the previous operating ratio of the freezing compartment fan and the current operating ratio of the freezing compartment fan) and a second factor (the difference between the reference operating ratio and the current operating ratio of the freezing compartment fan) for adjusting the cooling power of the freezing compartment compressor 21a.

The controller may determine the cooling power of the freezing compartment compressor 21a during operation of the refrigerating cycle based on the operating ratio of the refrigerating compartment fan 39a.

As described above in the first embodiment, the controller may compare the previous operating ratio of the refrigerating compartment fan 39a with the current operating ratio of the refrigerating compartment fan 39a and determine the cooling power of the freezing compartment compressor 21a during operation of the freezing cycle.

In another example, the controller may compare the reference operating ratio of the refrigerating compartment fan 39a with the current operating ratio of the refrigerating compartment fan 39a and determine the cooling power of the freezing compartment compressor 21a during operation of the freezing cycle.

In another example, the controller may maintain the cooling power of the freezing compartment compressor 21h in the current state or may increase or decrease the rotation speed of the refrigerating compartment fan 39a, based on a first factor (the difference between the previous operating ratio of the refrigerating compartment fan and the current operating ratio of the refrigerating compartment fan) and a second factor (the difference between the reference operating ratio and the current operating ratio of the refrigerating compartment fan) for adjusting the cooling power of the freezing compartment compressor 21b.

In the present disclosure, the rotation speed of the cooling fan and the angle of the damper may be collectively referred to as output. For example, the reference speed of the cooling fan and the reference angle of the damper may be referred to as reference output. In addition, the set speed of the cooling fan may be referred to as setting output of the cooling fan and the limited speed of the cooling fan may be referred to as the limited output of the cooling fan.

1. A method for controlling a refrigerator based on a first reference temperature and a second reference temperature that is less than the first reference temperature, the method comprising:
turning off a cold air transmission unit and operating a cold air generator with a first cooling power, which is previously determined, when a temperature of a storage compartment is equal to or less than the second reference temperature;
determining when the temperature of the storage compartment becomes equal to or greater than the first reference temperature;
turning on the cold air transmission unit and operating the cold air generator with the first cooling power when the temperature of storage compartment is equal to or greater than the first reference temperature;
determining when the temperature of the storage compartment becomes equal to or less than the second reference temperature;
calculating, by a controller, an operating ratio of the cold air transmission unit based on an ON time and an OFF time of the cold air transmission unit while operating the cold air generator with the first cooling power, upon determining that the temperature of the storage compartment is equal to or less than the second reference temperature, and determining a second cooling power of the cold air generator based on the operating ratio of the cold air transmission unit; and
operating the cold air generator with the determined second cooling power.

2. The method of claim 1, wherein the cold air generator includes a compressor, and
wherein the cold air transmission unit includes at least one of a cooling fan which operates to provide cold air to the storage compartment or a damper which opens or closes a passage for providing the cold air to the storage compartment.

3. The method of claim 1, wherein the cold air transmission unit is turned off again upon determining that the temperature of the storage compartment is equal to or less than the second reference temperature while operating the cold air generator with the second cooling power.

4. The method of claim 1, wherein the operating ratio of the cold air transmission unit is determined based on a ratio of an ON time to a sum of the ON time and the OFF time of the cold air transmission unit.

5. The method of claim 1, wherein the calculated operating ratio is a current operating ratio, and
wherein the controller determines the second cooling power of the cold air generator based on a difference between a previous operating ratio of the cold air transmission unit and the current operating ratio of the cold air transmission unit.

6. The method of claim 5, wherein the controller determines the second cooling power of the cold air generator to be when an absolute value of the difference between the previous operating ratio and the current operating ratio is equal to or greater than a first reference value, and
wherein the controller determines the second cooling power of the cold air generator to be maintained at the first cooling power, when the absolute value of the difference between the previous operating ratio and the current operating ratio is less than the first reference value.

7. The method of claim 6, wherein the controller determines the second cooling power of the cold air generator to be increased relative to the first cooling power, when the difference between the previous operating ratio and the current operating ratio is less than zero, and when the absolute value of the difference between the previous operating ratio and the current operating ratio is equal to or greater than the first reference value, and
Wherein the controller determines the second cooling power of the cold air generator to be decreased relative to the first cooling power, when the difference between the previous operating ratio and the current operating ratio is greater than zero, and when the absolute value of the difference between the previous operating ratio and the current operating ratio is equal to or greater than the first reference value.

8. The method of claim 6, wherein the controller determines the second cooling power of the cold air generator to be increased or decreased relative to the first cooling power by a first level, when the absolute value of the difference between the previous operating ratio and the current operating ratio is equal to or greater than the first reference value, and less than a second reference value which is greater than the first reference value, and
wherein the controller determines the second cooling power of the cold air generator to be increased or decreased relative to the first cooling power by a second level, which is greater than the first level, when the absolute value of the difference between the previous operating ratio and the current operating ratio is equal to or greater than the second reference value.

9. The method of claim 1, wherein the calculated operating ratio is a current operating ratio, and
wherein the controller determines the second cooling power of the cold air generator based on a difference between a reference operating ratio and the current operating ratio of the cold air transmission unit.

10. The method of claim 9, wherein the controller determines the second cooling power of the cold air generator to be increased or decreased relative to the first cooling power when an absolute value of the difference between the reference operating ratio and the current operating ratio is equal to or greater than a first reference value, and
wherein the controller determines the second cooling power of the cold air generator to be maintained at the first cooling power when the absolute value of the difference between the reference operating ratio and the current operating ratio is less than the first reference value.

11. The method of claim 10, wherein the controller determines the second cooling power of the cold air generator to be increased relative to the first cooling power when the difference between the reference operating ratio and the current operating ratio is less than zero, and the absolute value of the difference between the reference operating ratio and the current operating ratio is equal to or greater than the first reference value, and
wherein the controller determines the second cooling power of the cold air generator to be decreased relative to the first cooling power when the difference between the reference operating ratio and the current operating ratio is greater than zero, and the absolute value of the difference between the reference operating ratio and the current operating ratio is equal to or greater than the first reference value.

12. The method of claim 10, wherein the controller determines the second cooling power of the cold air generator to be increased or decreased relative to the first cooling power by a first level, when the absolute value of the difference between the reference operating ratio and the current operating ratio is equal to or greater than the first reference value and less than a second reference value which is greater than the first reference value, and
wherein the controller determines the second cooling power of the cold air generator to be increased or decreased relative to the first cooling power by a second level, which is greater than the first level, when the absolute value of the difference between the reference operating ratio and the current operating ratio is equal to or greater than the second reference value.

13. The method of claim 1, wherein the calculated operating ratio is a current operating ratio, and
wherein the controller determines the second cooling power of the cold air generator based on a first factor which is a difference between a previous operating ratio of the cold air transmission unit and the current operating ratio of the cold air transmission unit, and a second factor which is a difference between a reference operating ratio and the current operating ratio of the cold air transmission unit.

14. The method of claim 13, further comprising:
determining, by the controller, whether to increase, maintain, or decrease the second cooling power of the cold air generator by combining a result from the first factor with a result from the second factor, after determining the second cooling power of the cold air generator based on the first factor and the second factor.

15. A method for controlling a refrigerator including a first storage compartment, a second storage compartment to receive cold air from the first storage compartment, a temperature sensor to sense a temperature of the second storage compartment, a cooling fan to supply the cold air to the second storage compartment from the first storage compartment, and a compressor to cool the first storage compartment, the method comprising:
turning off the cooling fan and operating the compressor with a first cooling power, which is previously determined, when a temperature of the second storage compartment is equal to or less than a second reference temperature that is less than a first reference temperature;
determining when the temperature of the second storage compartment becomes equal to or greater than the first reference temperature;
turning on the cooling fan and operating the compressor with the first cooling power, when the temperature of the second storage compartment is equal to or greater than the first reference temperature;
determining when the temperature of the second storage compartment is equal to or less than the second reference temperature;
calculating, by a controller, an operating ratio of the cooling fan based on an ON time and an OFF time of the cooling fan while operating the cold air generator with the first cooling power, upon determining that the temperature of the second storage compartment is equal to or less than the second reference temperature, and determining a second cooling power of the compressor based on the operating ratio of the cooling fan; and
operating the compressor with the determined second cooling power.

16. The method of claim 15, wherein the first storage compartment is a freezing compartment, and the second storage compartment is a refrigerating compartment.

17. The method of claim 15, wherein the calculated operating ratio of the cooling fan is a current operating ratio, and
wherein the controller determines the second cooling power of the compressor based on a difference between a previous operating ratio of the cooling fan and the current operating ratio of the cooling fan.

18. The method of claim 15, wherein the calculated operating ratio of the cooling fan is a current operating ratio, and
wherein the controller determines the second cooling power of the compressor based on a difference between a reference operating ratio and the current operating ratio of the cooling fan.

19. The method of claim 15, wherein the calculated operating ratio of the cooling fan is a current operating ratio, and
wherein the controller determines the second cooling power of the compressor, based on a first factor which is a difference between a previous operating ratio of the cooling fan and the current operating ratio of the cooling fan, and a second factor which is a difference between a reference operating ratio and the current operating ratio of the cooling fan.

20. The method of claim 15, wherein the operating ratio of the cooling fan is determined based on a ratio of an ON time to a sum of the ON time and the OFF time of the cooling fan.
